(19) United States
(12) Patent Application Publication
(10) Pub. No.: US 2015/0172486 A1
(43) Pub. Date: Jun. 18, 2015

(54) IMAGE PROCESSING SYSTEM, IMAGE FORMING APPARATUS, METHOD FOR DISPLAYING OPERATING SCREEN, AND STORAGE MEDIUM

(71) Applicant: KONICA MINOLTA, INC., Tokyo (JP)

(72) Inventors: Toshihisa MOTOSUGI, Okazaki-shi (JP); Hiroaki Sugimoto, Nagoya-shi (JP); Shohei Ichiyama, Toyokawa-shi (JP); Mie Kawabata, Toyokawa-shi (JP); Yoichi Kurumasa, Toyokawa-shi (JP)

(21) Appl. No.: 14/568,574

(22) Filed: Dec. 12, 2014

(30) Foreign Application Priority Data
Dec. 13, 2013 (JP) 2013-257602

(51) Int. Cl. H04N 1/00

(52) U.S. Cl. CPC H04N 1/00506; H04N 1/00411; H04N 1/00413; H04N 2201/0094; H04N 2201/3273

(57) ABSTRACT

A first image forming apparatus includes a first display and a first touch panel, calculates a location-on-display-surface which indicates a position, on a first display surface of the first display, corresponding to a first touched position on the first touch panel based on first data which shows a positional relationship between the first display surface and the first touch panel, and generates log which indicates, for each time, the calculated location-on-display-surface. A second image forming apparatus includes a second display and a second touch panel, calculates a corresponding position, in the second touch panel, which corresponds to the location-on-display-surface indicated in the log based on second data which shows a positional relationship between a second display surface of the second display and the second touch panel, and displays, on the second display, a screen by using the corresponding position as a second touched position on the second touch panel.

This application is based on Japanese patent application No. 2013-257602 filed on Dec. 13, 2013, the contents of which are hereby incorporated by reference.

### BACKGROUND OF THE INVENTION

1. Field of the Invention

The present invention relates to a technology for displaying an image on a display unit in accordance with operation performed on a touch-sensitive panel.

2. Description of the Related Art

Recent years have seen the widespread use of image forming apparatuses having a variety of functions such as copying, scanning, faxing, network printing, and box function (document server function). Such image forming apparatuses are sometimes called “multifunction devices” or “Multi-Functional Peripherals (MFPs)”.

A variety of secondary functions to be used in combination with the foregoing functions has been developed in relation to improvement in hardware such as an Auto Document Feeder (ADF), a print engine, a Central Processing Unit (CPU), a Random Access Memory (RAM), and a large-capacity storage, and also in relation to improvement in environment for software development.

As described above, the functions of image forming apparatuses are expanded. The expansion of functions makes it possible for a user to cause such an image forming apparatus to execute various processing.

As the kind of processing executable by the image forming apparatus increases, operation on the image forming apparatus tends to be complicated. Likewise, as the kind of such processing increases, operation for settings to be performed by an administrator also tends to be complicated.

To address this, a method has been proposed in which a log of sample operation is recorded in advance and operation is reproduced based on the log for a user who wishes to know how to make operation (Japanese Laid-open Patent Publication No. 2000-235549). According to the method, the user is allowed to check how to perform operation by seeing a transition of screens displayed on a display unit at a time when the operation is reproduced.

Such an operation log is distributed to users, which enables operation to be reproduced in image forming apparatuses of the users.

In the meantime, image forming apparatuses sometimes have different condition values set for many matters. In view of this, a method described below has been proposed to ensure reproduction of operation.

When recording operation with an automatic reproduction function, although operation content which is operated with an operation panel in a predetermined recording period is recorded on a memory for operation recording in a time sequence as a specific operation procedure, before the recording, various setting values (setting data) set to an actual machine are recorded in association with the specific operation procedure to be recorded. Then, when the operation is reproduced with the automatic reproduction function, the various setting values set to the actual machine are first changed to setting values recorded in association with the specific operation procedure to be reproduced, and, after that, the specific operation procedure to be reproduced is reproduced (English abstract of Japanese Laid-open Patent Publication No. 2012-75014).

Meanwhile, a touch panel display is a device in which a touch panel is laid on the display surface of a display. In some cases, touch panel displays are slightly different from one another in position at which the touch panel is laid on the display surface of the display. Accordingly, data is prepared in each of the touch panel displays. The data indicates the correspondence relation between the position of the display surface of the display and the position of the touch panel. For each of the touch panel displays, a position, on the display surface, which corresponds to a position touched on the touch panel is calculated based on the data on the subject touch panel display.

According to the method described in Japanese Laid-open Patent Publication No. 2012-75014, however, where touch panel displays are different from one another in position at which a touch panel is laid on the display surface of a display, unfortunately, operation sometimes cannot be reproduced appropriately in an image forming apparatus based on a log recorded by another image forming apparatus.

### SUMMARY

The present invention has been achieved in light of such an issue, and an object thereof is to reproduce user operation more accurately than with conventionally possible even if touch panel displays are different from one another in position at which a touch panel is laid on the display surface of a display.

An image processing system according to an aspect of the present invention is an image processing system including: a first image forming apparatus including a first display and a first touch panel laid on a display surface of the first display; and a second image forming apparatus including a second display and a second touch panel laid on a display surface of the second display. The first image forming apparatus includes a first calculation portion configured to calculate a location-on-display-surface which indicates a position, on the display surface of the first display, corresponding to a first touched position on the first touch panel based on first positional relationship data which shows a positional relationship between the display surface of the first display and the first touch panel, and a generation portion configured to generate operation log data which indicates, for each predetermined time, the location-on-display-surface calculated by the first calculation portion. The second image forming apparatus includes a second calculation portion configured to calculate a corresponding position, in the second touch panel, which corresponds to the location-on-display-surface indicated in the operation log data based on second positional relationship data which shows a positional relationship between the display surface of the second display and the second touch panel, a determination portion configured to determine display control processing of displaying, on the second display, an operating screen by using the corresponding position calculated by the second calculation portion as a second touched position on the second touch panel, and a display control portion configured to execute the display control processing determined by the determination portion.

These and other characteristics and objects of the present invention will become more apparent by the following descriptions of preferred embodiments with reference to drawings.

### BRIEF DESCRIPTION OF THE DRAWINGS

FIG. 1 is a diagram showing an example of a network system.

FIG. 2 is a diagram showing an example of an external view and an internal view of an image forming apparatus.

FIG. 3 is a diagram showing an example of the hardware configuration of an image forming apparatus.

FIG. 4 is a diagram showing an example of the configuration of an operating panel unit.

FIGS. 5A and 5B are diagrams showing examples as to how a liquid crystal display and a touch panel overlap each other.

FIG. 6 is a diagram showing an example of a copy job screen.

FIG. 7 is a schematic diagram for depicting the relationship between an icon row and a copy job screen.

FIG. 8 is a diagram showing an example of the functional configuration of an image forming apparatus and the flow of data in recording operation.

FIGS. 9A and 9B are diagrams for depicting the relationship between touch panel coordinates and display surface coordinates.

FIGS. 10A-10C are diagrams showing examples of a basic touch action.

FIGS. 11A and 11B are diagrams showing examples of a fax transmission job screen.

FIG. 12 is a diagram showing an example of operation log data.

FIG. 13 is a diagram showing an example of the functional configuration of an image forming apparatus and the flow of data in reproducing operation.

FIG. 14 is a diagram showing an example of the positional relationship among touch panel coordinates and display surface coordinates of one image forming apparatus, and touch panel coordinates of another image forming apparatus.

FIGS. 15A and 15B are diagrams showing an example of a hardware key panel lower screen and a hardware key panel right screen, respectively.

FIG. 16 is a flowchart depicting an example of the flow of the entire processing performed by an image forming apparatus.

FIG. 17 is a flowchart depicting an example of the flow of record processing.

FIG. 18 is a flowchart depicting an example of the flow of reproduction processing.

FIG. 19 is a flowchart depicting an example of the flow of reproduction processing.

FIG. 20 is a diagram showing an example of a screen transition and user operation for the case where operation log data is generated.

FIG. 21 is a diagram showing an example of a screen transition and user operation for the case where operation log data is generated.

FIG. 22 is a diagram showing an example of a screen transition and user operation for the case where operation log data is generated.

FIG. 23 is a diagram showing an example of screen transition for the case where operation is reproduced.

FIG. 24 is a diagram showing an example of screen transition for the case where operation is reproduced.

FIG. 25 is a diagram showing an example of screen transition for the case where operation is reproduced.

FIG. 26 is a diagram showing an example of screen transition for the case where operation is reproduced.

FIG. 27 is a diagram showing another example of the positional relationship among touch panel coordinates and display surface coordinates of one image forming apparatus, and touch panel coordinates of another image forming apparatus.

FIGS. 28A-28C are diagrams showing examples of the positional relationship between display surface coordinates and an object.

### DESCRIPTION OF THE PREFERRED EMBODIMENTS

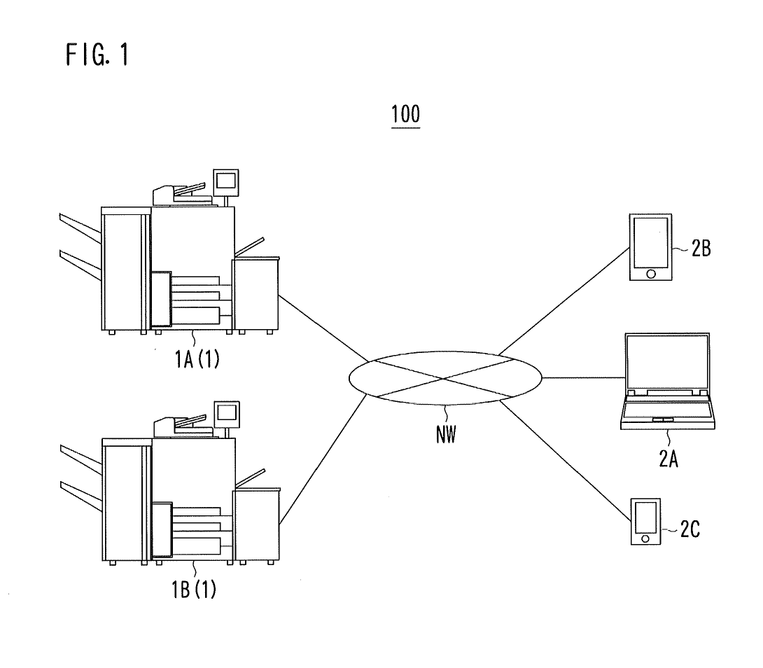

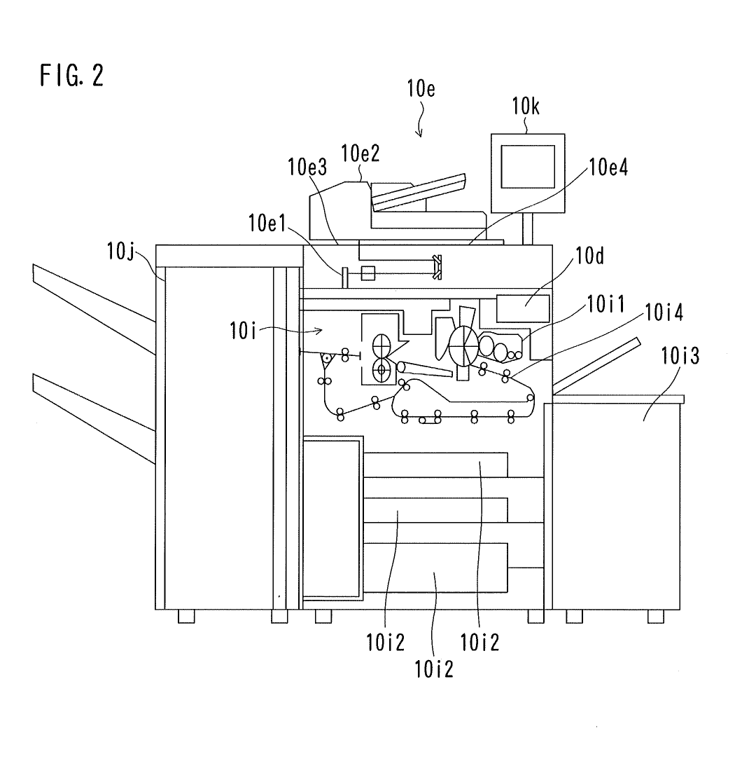

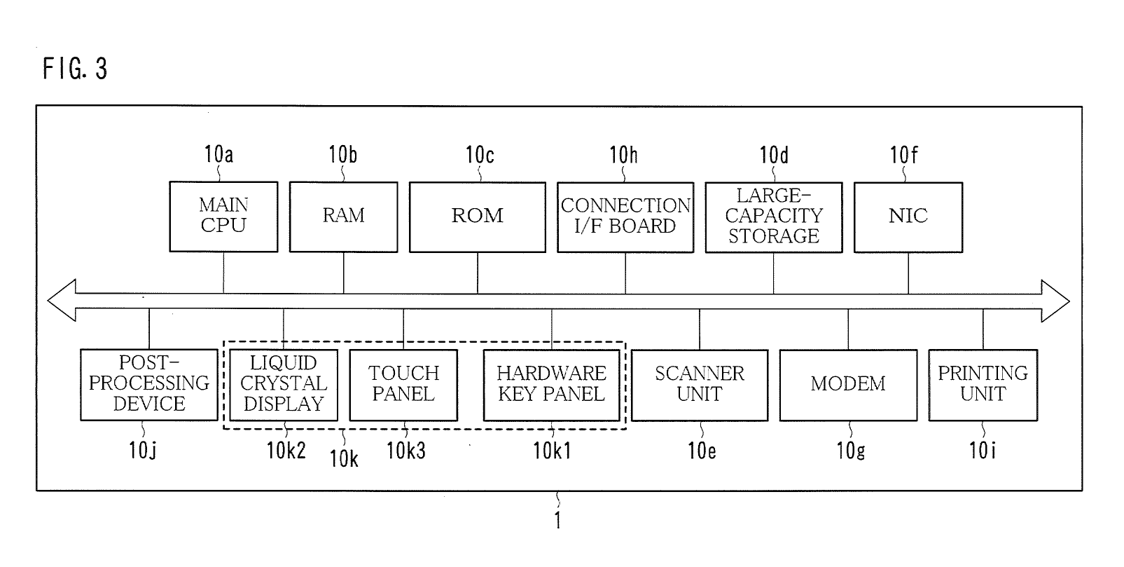

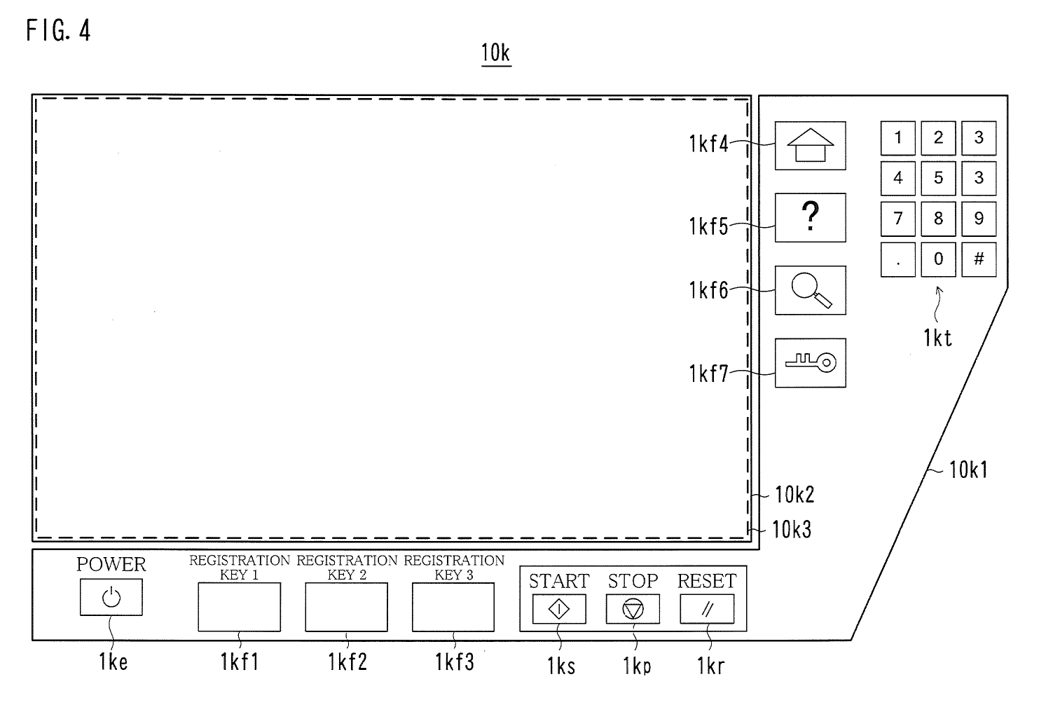

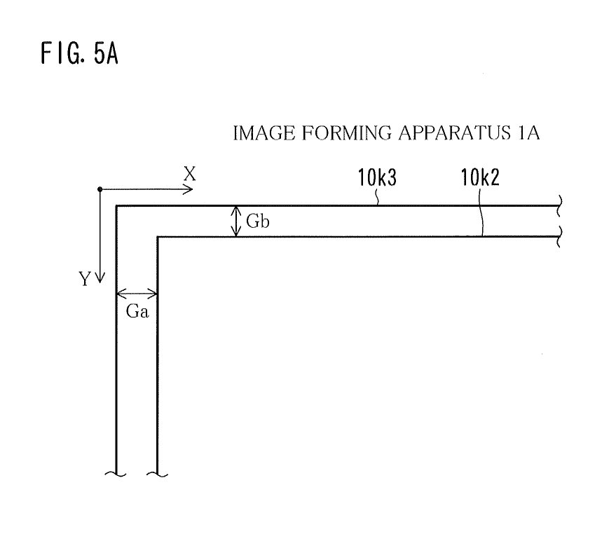

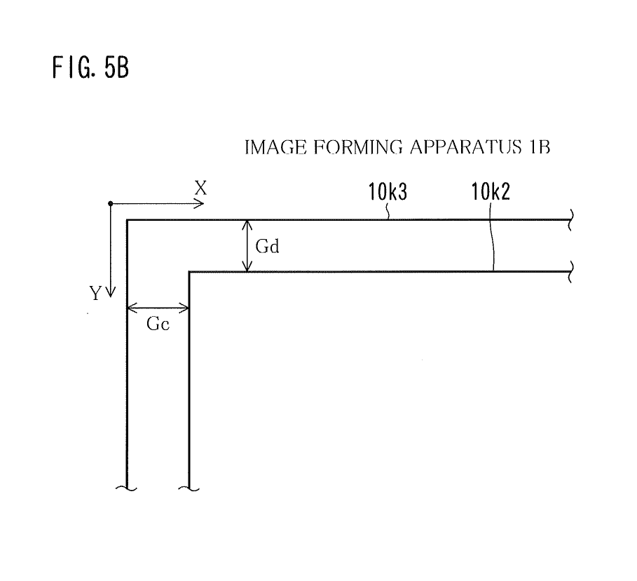

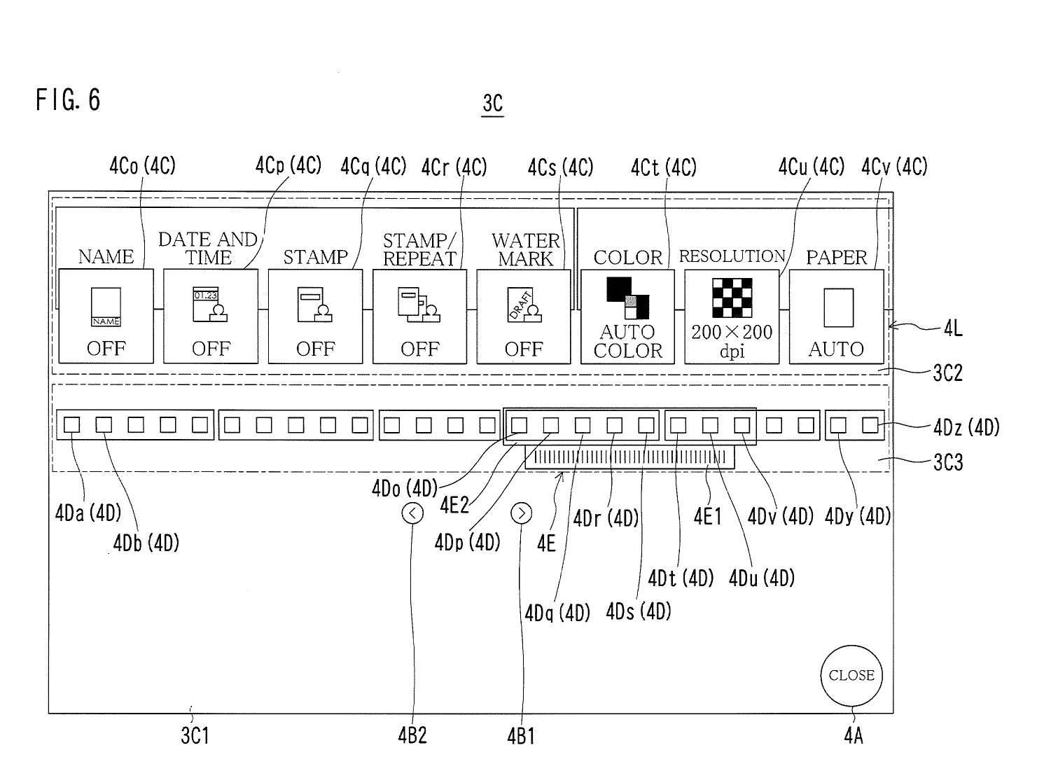

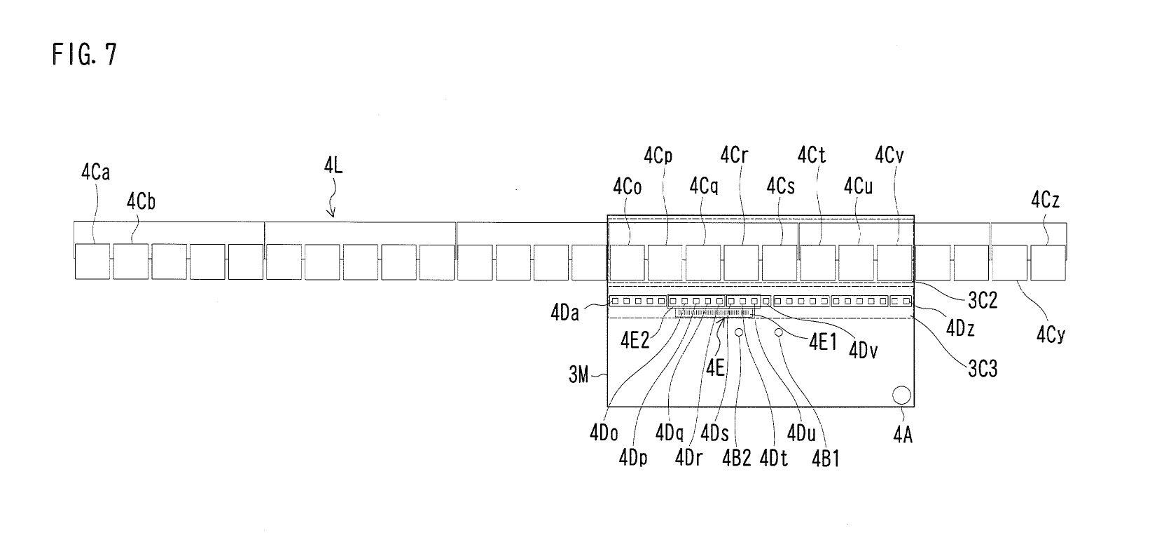

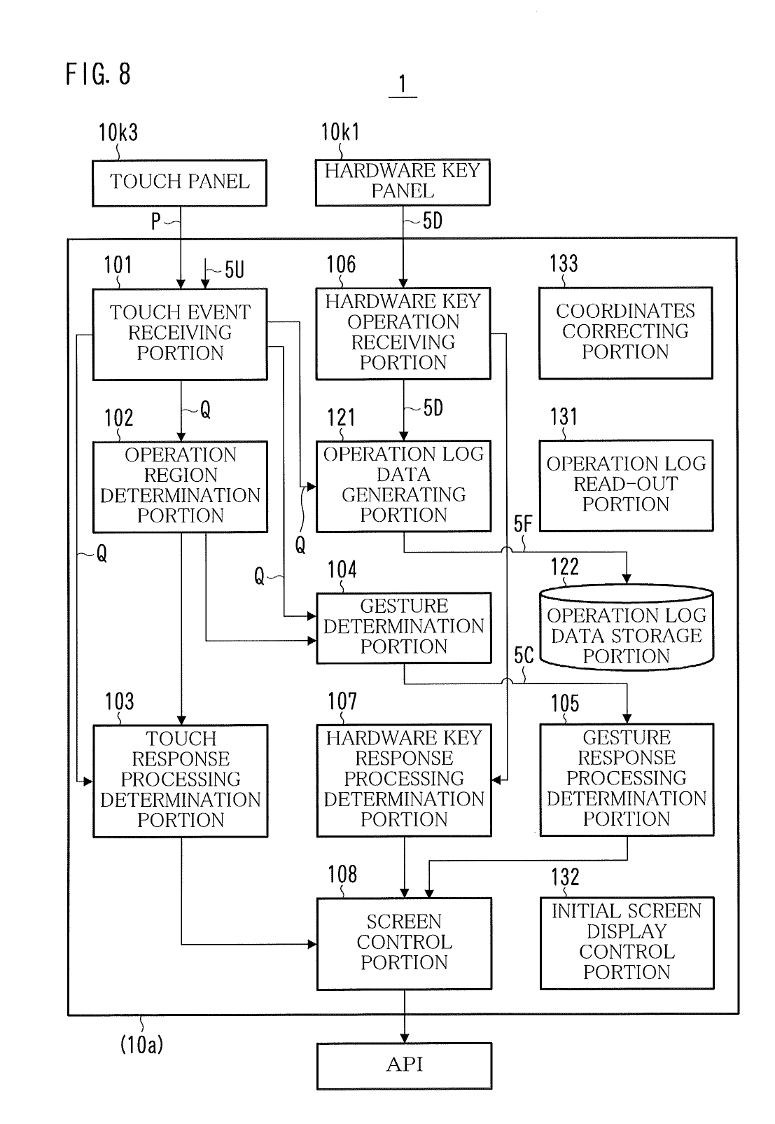

FIG. 1 is a diagram showing an example of a network system 100. FIG. 2 is a diagram showing an example of an external view and an internal view of an image forming apparatus 1. FIG. 3 is a diagram showing an example of the hardware configuration of the image forming apparatus 1. FIG. 4 is a diagram showing an example of the configuration of an operating panel unit 10k. FIGS. 5A and 5B are diagrams showing examples as to how a liquid crystal display 10k2 and a touch panel 10k3 overlap each other. FIG. 6 is a diagram showing an example of a copy job screen 3C. FIG. 7 is a schematic diagram for depicting the relationship between an icon row 4L and the copy job screen 3C. FIG. 8 is a diagram showing an example of the functional configuration of the image forming apparatus 1 and the flow of data in recording operation.

As shown in FIG. 1, the network system 100 is configured of a plurality of the image forming apparatuses 1, a plurality of terminals 2A-2C, a communication line NW, and so on. The image forming apparatuses 1 and the terminals 2A-2C are configured to perform communication with one another via the communication line NW. Examples of the communication line NW are a public line, a dedicated line, the Internet, and a Local Area Network (LAN). Hereinafter, the image forming apparatuses 1 may be described separately as an “image forming apparatus 1A”, an “image forming apparatus 1B”, . . . , and so on.

The image forming apparatus 1 is an image processing apparatus that is generally called a “Multi-Functional Peripheral (MFP)” or a “multifunction device”. The image forming apparatus 1 is an apparatus into which functions such as copying, network printing, faxing, scanning, and box function are combined.

The box function is a function in which a storage area called a “box” or “personal box” is allocated to each user. The box function enables each user to save document data such as an image file to his/her storage area and to manage the document data therein. The box corresponds to a “folder” or “directory” in a personal computer.

Examples of the terminals 2A-2C are a personal computer, a smartphone, and a tablet computer.

Referring to FIG. 2 or FIG. 3, the image forming apparatus 1 is configured of a main Central Processing Unit (CPU) 10a, a Random Access Memory (RAM) 10b, a Read Only Memory (ROM) 10c, a large-capacity storage 10d, a scanner unit 10e, a Network Interface Card (NIC) 10f, a modem 10g, a connection interface board 10h, a printing unit 10i, a post-processing device 10j, an operating panel unit 10k, and so on.

The scanner unit 10e optically reads an image from a sheet of paper in which a photograph, character, picture, or chart is recorded, and generates image data thereof. To be specific, the scanner unit 10e is configured of an image sensor 10e1, an Auto Document Feeder (ADF) 10e2, a read slit 10e3, a platen glass 10e4, and so on.

The ADF 10e2 is operable to convey each sheet of paper placed thereon to the read slit 10e3. When the sheet of paper passes through the read slit 10e3, the image sensor 10e1 optically reads an image from the sheet of paper to generate image data of the image. In the case where a user places a document on the platen glass 10e4, the image sensor 10e1 scans the platen glass 10e4 to optically read an image from the document sheet, and generates image data of the image.

The NIC 10f performs communication with devices such as the terminals 2A-2C in accordance with a protocol such as Transmission Control Protocol/Internet Protocol (TCP/IP).

The modem log performs communication with a fax terminal in accordance with a protocol such as a G3 through a fixed telephone network.

The connection interface board 10h is to connect peripheral devices to the image forming apparatus 1. Examples of the connection interface board 10h are a Universal Serial Bus (USB) board and an Institute of Electrical and Electronics Engineers (IEEE) 1394 board.

The printing unit 10i prints an image captured by the scanner unit 10e, or an image inputted through the NIC 10f, the modem 10g, or the connection interface board 10h. To be specific, the printing unit 10i is configured of an engine portion 10i1, a paper feed tray 10i2, a large capacity paper feed portion 10i3, a sheet carrying mechanism 10i4, and so on.

One or more paper feed trays 10i2 are provided in the printing unit 10i. Each of the paper feed trays 10i2 houses therein paper (blank paper) having a predetermined size. The large capacity paper feed portion 10i3 also houses therein paper (blank paper) having a predetermined size. The large capacity paper feed portion 10i3 has a capacity larger than that of each of the paper feed trays 10i2. The large capacity paper feed portion 10i3 therefore stores therein paper of size most often used.

The sheet carrying mechanism 10i4 serves to convey each sheet of paper from the paper feed tray 10i2 or the large capacity paper feed portion 10i3 to the engine portion 10i1. The engine portion 10i1 serves to print an image onto the sheet of paper. The sheet carrying mechanism 10i4 outputs the sheet of paper which has been subjected to printing to a paper output tray or bin. If post-processing such as stapling or punching is to be performed, then the paper on which the image has been printed is conveyed to the post-processing device 10j.

The post-processing device 10j serves to apply the foregoing post-processing appropriately to the sheet or the sheets of paper on which the image has been printed.

The operating panel unit 10k is a user interface unit. As shown in FIG. 4, the operating panel unit 10k is configured of a hardware key panel 10k1, a liquid crystal display (LCD) 10k2, a touch panel 10k3, and so on.

The hardware key panel 10k1 is an input device which is configured of numeric keys 1kt, a start key 1ks, a stop key 1kp, a reset key 1kr, a power key 1ke, function keys 1kf1-1kf7, and so on. These keys are generally called “hardware keys” to be distinguished from keys displayed on the liquid crystal display 10k2 (so-called software keys). Among the function keys 1kf1-1kf7, the function key 1kf2 is assigned a command to start/finish recording operation (discussed later). The function key 1kf4 is assigned a command to display a home screen 3T (described later). The function key 1kf2 and the function key 1kf4 are therefore referred to as a “start/end command key 1kf2” and a “home key 1kf4”, respectively.

The liquid crystal display 10k2 displays, for example, a screen for presenting messages to a user, a screen showing the results of processing, and a screen for allowing a user to input a command or conditions to the image forming apparatus 1.

The touch panel 10k3 is fixedly mounted so as to cover the entirety of the display surface of the liquid crystal display 10k2. The touch panel 10k3 is operable to detect a location touched (pressed) and to inform the main CPU 10a of the location. The touch panel 10k3 may be an electrostatic capacitance touch panel, a surface acoustic wave touch panel, or an electrostatic capacitance touch panel, for example. Hereinafter, an example is described in which settings are so made that a pixel pitch of the liquid crystal display 10k2 becomes equal to a readout resolution of the touch panel 10k3. Another example is described in which the individual image forming apparatuses 1 are equal to one another in performance of the liquid crystal display 10k2, and in performance of the touch panel 10k3.

In the meantime, the positional relationship between the liquid crystal display 10k2 and the touch panel 10k3 is different among the image forming apparatuses 1. As shown in FIG. 5A, in the image forming apparatus 1A, the upper left corner of the liquid crystal display 10k2 is shifted rightward (in the X-axis direction) by “Ga” and shifted downward (in the Y-axis direction) by “Gb” with respect to the upper left corner of the touch panel 10k3. On the other hand, in the image forming apparatus 1B, the upper left corner of the liquid crystal display 10k2 is shifted by “Gc” in the X-axis direction and shifted by “Gd” in the Y-axis direction with respect to the upper left corner of the touch panel 10k3.

If there are no shifts between the liquid crystal display 10k2 and the touch panel 10k3, coordinates of a position touched on the touch panel 10k3 may be used as coordinates of a position touched on the liquid crystal display 10k2 without making shift-related correction. Hereinafter, coordinates on the touch panel 10k3 are referred to as “touch panel coordinates P” or “touch panel coordinates P (Xp, Yp)”.

If it is found out that there is a shift between the liquid crystal display 10k2 and the touch panel 10k3, then the shift-related correction is necessary. With the image forming apparatus 1A, correction is necessary to match the coordinates of the touch panel coordinates P with the coordinates (Xp-Ga, Yp-Gb). With the image forming apparatus 1B, correction is necessary to match the coordinates of the touch panel coordinates P with the coordinates (Xp-Gc, Yp-Gd).

In this way, the shift amount of the touch panel 10k3 with respect to the liquid crystal display 10k2 is used as the correction amount. In view of this, the shift amount is hereinafter referred to as the “correction amount”.

Each of the image forming apparatuses 1 stores, in advance, therein correction amount data 5U indicating the correction amount for the subject image forming apparatus 1. To be specific, the image forming apparatus 1A stores, in advance, correction amount data 5U indicating (Ga, Gb). The image forming apparatus 1B stores, in advance, correction amount data 5U indicating (Gc, Gd).

The liquid crystal display 10k2 displays a variety of screens thereon. Each of the screens has different types of objects. For example, referring to FIG. 6, the copy job screen 3C has objects such as a close button 4A, a right scroll button 4B1, a left scroll button 4B2, a plurality of optional function icons 4C, a plurality of markers 4D, and a slider 4E.

The close button 4A is to close the copy job screen 3C to display again the immediately preceding screen on the liquid crystal display 10k2.

The optional function icons 4C represent optional functions. One optional function icon 4C corresponds to one optional function of the image forming apparatus 1. The optional function icons 4C are arranged in a single horizontal row to form an icon row 4L. However, all the optional function icons 4C cannot be displayed at one time. To be specific, as shown in FIG. 7, only some of the optional function icons 4C appear on the copy job screen 3C, and the other optional function icons 4C do not appear thereon.

The user scrolls across the icon row 4L to display the other optional function icons 4C sequentially. Hereinafter, the optional function icons 4C are sometimes differentiated by denoting an “optional function icon 4Ca”, an “optional function icon 4Cb”, . . . , and an “optional function icon 4Cz” in order from left to right.

The right scroll button 4B1 is to scroll across the icon row 4L from right to left. The left scroll button 4B2 is to scroll across the icon row 4L from left to right.

As with the optional function icons 4C, the markers 4D are arranged in a single horizontal row. The number of markers 4D is the same as the number of optional function icons 4C. The markers 4, sequentially from left to right, correspond to an optional function icon 4Ca, an optional function icon 4Cb, . . . , and an optional function icon 4Cz. All the markers 4D appear on the copy job screen 3C at one time. Hereinafter, the markers 4D corresponding to the optional function icon 4Ca, the optional function icon 4Cb, . . . , and the optional function icon 4Cz are sometimes referred to as a “marker 4Da”, a “marker 4Db”, . . . , and a “marker 4Dz”, respectively.

The slider 4E includes a slider bar 4E1 and a window 4E2. The slider bar 4E1 moves to left or right in response to drag or flick.

The window 4E2 is provided right above the slider bar 4E1. The markers 4D corresponding to the optional function icons 4C currently appearing on the copy job screen 3C are enclosed by the window 4E2.

The window 4E2 is provided to attach to the slider bar 4E1. The window 4E2 therefore moves together with the movement of the slider bar 4E1. The user operates the slider bar 4E1 to change the markers 4D enclosed by the window 4E2. Along with the change of the markers 4D enclosed by the window 4E2, the icon row 4L is scrolled through, so that the optional function icons 4C appearing on the copy job screen 3C are changed.

The user also drags or flicks the icon row 4L directly to scroll through the same.

When the icon row 4L is scrolled through in response to operation on the right scroll button 4B1 or the left scroll button 4B2, the slider 4E moves depending on as to how the optional function icons 4C appear on the copy job screen 3C.

In the meantime, the liquid crystal display 10k2 displays a screen having only one region in some cases, and displays a screen having a plurality of sectioned regions in other cases. Hereinafter, a constituent region of the screen is referred to as an “element region”. The element region is classified into two types of a simple operation region and a gesture region.

The “simple operation region” is a region in which, as user action (operation), only tap is received. In contrast, the “gesture region” is a region in which, as the user action, tap, flick, drag, double-tap, and so on are received.

It is determined in advance which element region each pixel of each screen is located in, and which of the simple operation region and the gesture region each element region corresponds to. Such determination is defined in data for display (such data is hereinafter referred to as “screen data 5W”) on each screen.

Referring to FIG. 6, the copy job screen 3C is divided into a first element region 3C1, a second element region 3C2, and a third element region 3C3. The first element region 3C1 is set as the simple operation region, and each of the second element region 3C2 and the third element region 3C3 is set as the gesture region.

Referring back to FIGS. 2 and 3, the ROM 10c or the large-capacity storage 10d stores, therein, programs for implementing the functions such as copying and network printing. As shown in FIG. 8, the ROM 10c or the large-capacity storage 10d also stores, therein, programs for implementing the functions of a touch event receiving portion 101, an operation region determination portion 102, a touch response processing determination portion 103, a gesture determination portion 104, a gesture response processing determination portion 105, a hardware key operation receiving portion 106, a hardware key response processing determination portion 107, a screen control portion 108, an operation log data generating portion 121, an operation log data storage portion 122, an operation log read-out portion 131, an initial screen display control portion 132, a coordinates correcting portion 133, and so on.

The programs are loaded into the RAM 10b as necessary, and are executed by the main CPU 10a.

The touch event receiving portion 101 through the coordinates correcting portion 133 shown in FIG. 8 control the individual pieces of hardware, based on operation performed by the user on the operating panel unit 10k, in such a manner that a screen is displayed or a job is executed. The touch event receiving portion 101 through the coordinates correcting portion 133 also record an operation log to reproduce operation later based on the recorded operation log.

Hereinafter, the processing by the touch event receiving portion 101 through the coordinates correcting portion 133 shall be described, the descriptions being broadly divided into basic processing based on operation, processing for making a record of operation, and processing for reproducing operation based on the record. A mode in which processing is performed depending on real-time operation by the user is hereinafter referred to as a “normal mode”. A mode in which processing is performed by reproducing operation based on a record is hereinafter referred to as a “reproduction mode”.

[Basic Processing Based on Operation]

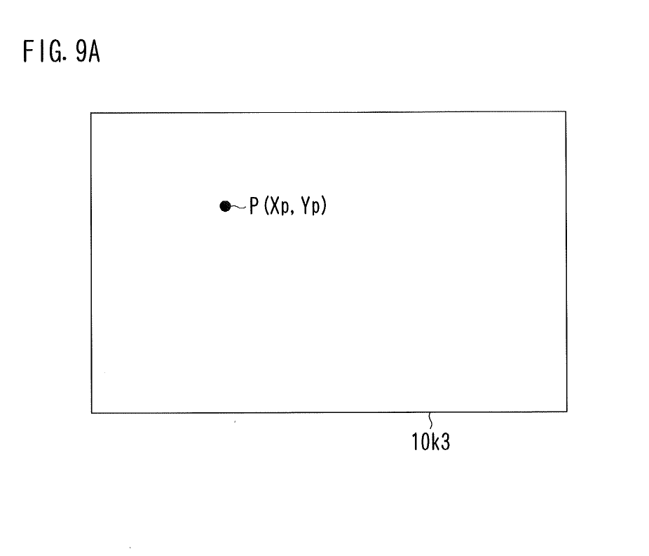

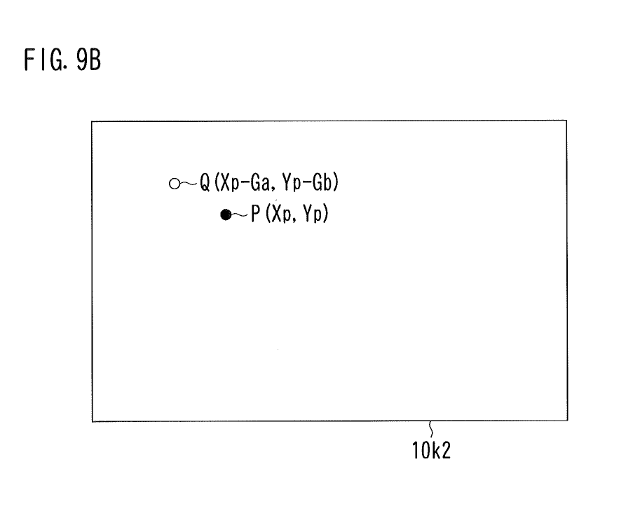

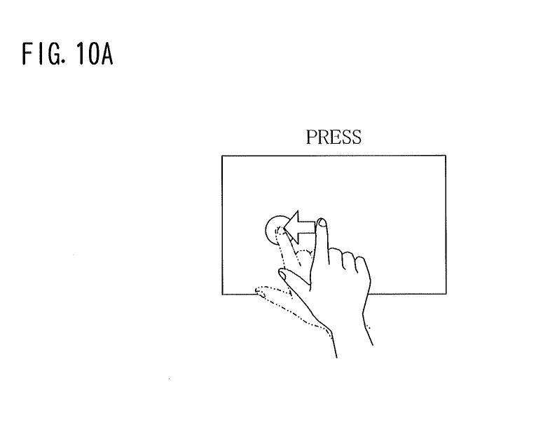

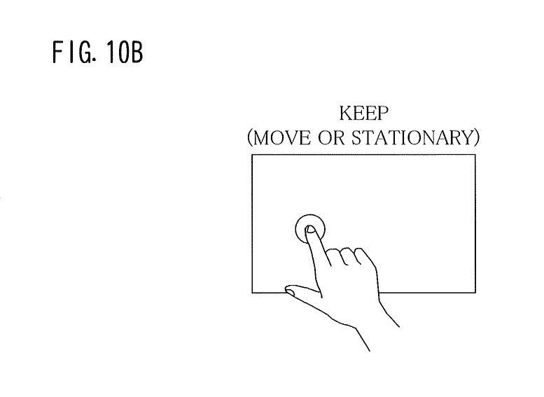

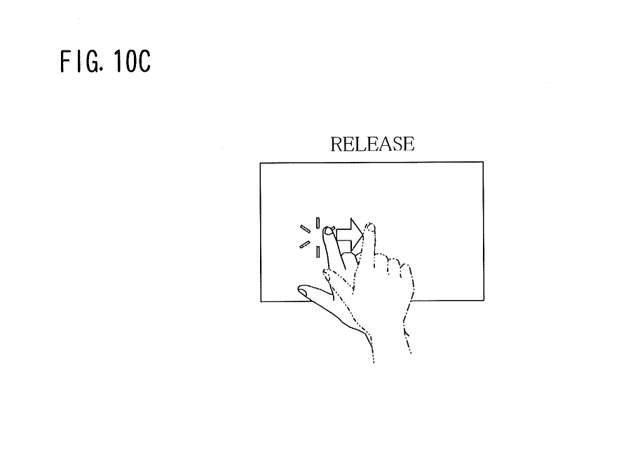

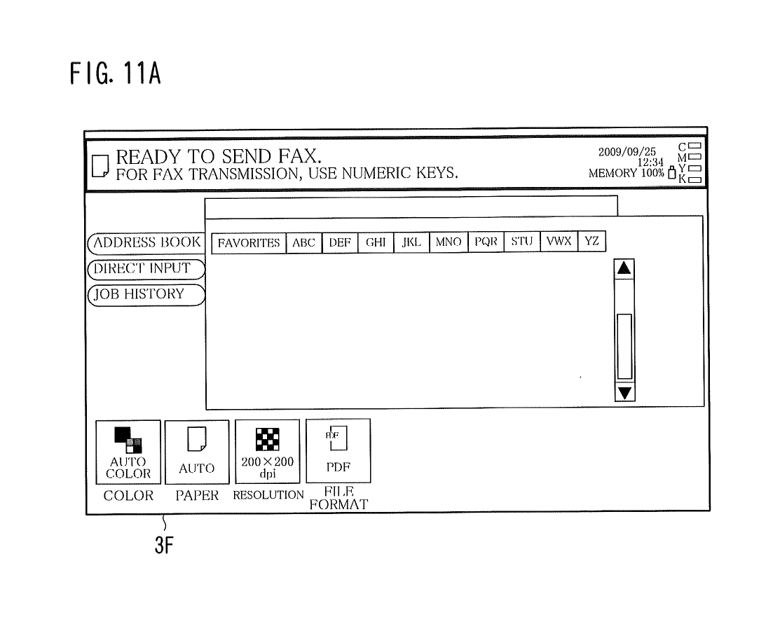

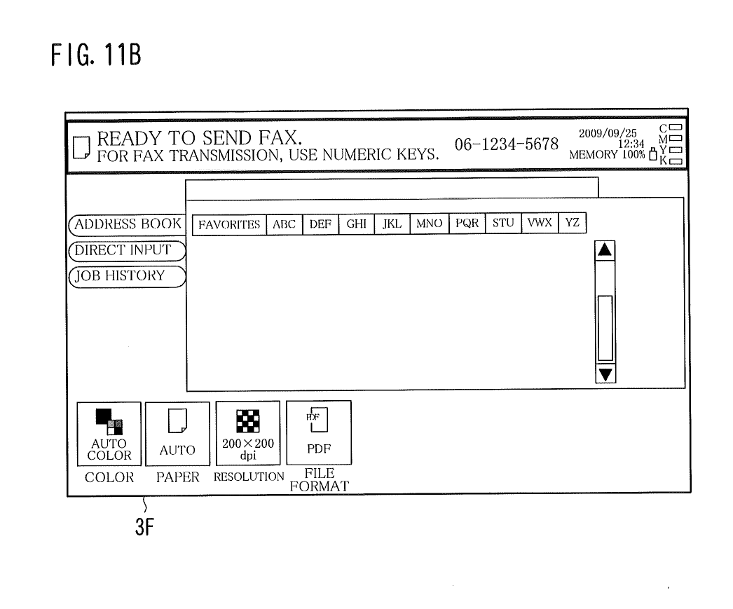

FIGS. 9A and 9B are diagrams for depicting the relationship between touch panel coordinates P and display surface coordinates Q. FIGS. 10A-10C are diagrams showing examples of a basic touch action. FIGS. 11A and 11B are diagrams showing examples of a fax transmission job screen 3F.

The touch event receiving portion 101 through the screen control portion 108 shown in FIG. 8 performs, in the normal mode, processing as discussed below in accordance with operation performed in real time, by the user, on the hardware key panel 10k1 or the touch panel 10k3.

When detecting a touch by a finger or pen, the touch panel 10k3 outputs touch panel coordinates P of the touched position on the touch panel for every predetermined time Ta until the touch is finished, namely, until the finger or pen ceases contact with the touch panel 10k3.

Every time receiving the touch panel coordinates P, the touch event receiving portion 101 corrects the touch panel coordinates P based on the correction amount data 5U. The touch event receiving portion 101 thereby calculates coordinates on the display surface of the liquid crystal display 10k2. Hereinafter, the coordinates on the display surface are referred to as “display surface coordinates Q” or “display surface coordinates Q (Xq, Yq). For example, as for the image forming apparatus 1A, the display surface coordinates Q are calculated by correcting the touch panel coordinates P (Xp, Yp) of FIG. 9A to the display surface coordinates Q (Xp-Ga, Yp-Gb) of FIG. 9B.

Further, every time the touch event receiving portion 101 receives the touch panel coordinates P, and, when detection of a touch stops, the touch event receiving portion 101 detects an event on the touch panel 10k3 (such an event being referred to as a “touch event”) in the following manner.

If the touch event receiving portion 101 received no touch panel coordinates P the predetermined time Ta before the current time, and receives touch panel coordinates P this time, then the touch event receiving portion 101 detects, as the touch event, a “press” as shown in FIG. 10A.

After the detection of the press, if the touch event receiving portion 101 detects touch panel coordinates P for every predetermined time Ta, then the touch event receiving portion 101 detects, as the touch event, a “keep” as shown in FIG. 10B. In general, the keep can be classified into a “move” in which the touch location changes and a “stationary” in which the touch location does not change. The “move” and the “stationary” may be detected distinctively from each other. However, in this embodiment, the “keep” is detected without any distinction between the “move” and the “stationary”.

If the touch event receiving portion 101 does not receive any touch panel coordinates P for time longer than the predetermined time Ta, namely, if detection of a touch stops, then the touch event receiving portion 101 detects, as the touch event, a “release” as shown in FIG. 10C.

When the touch event receiving portion 101 detects a press, the operation region determination portion 102 determines, based on the screen data 5W, what type of region the display surface coordinates Q for the press are located in. To be specific, the operation region determination portion 102 determines an element region in which a pixel of the display surface coordinates Q on the current screen is located. The operation region determination portion 102 then determines the type of a region (simple operation region or gesture region) set as the element region.

The touch response processing determination portion 103, the gesture determination portion 104, and the gesture response processing determination portion 105 perform the processing described below in accordance with the result of determination by the operation region determination portion 102.

When the element region where the display surface coordinates Q are located is determined to be a simple operation region, the touch response processing determination portion 103 determines processing to be executed in response to the touch event by the user. Hereinafter, the processing is referred to as “touch response processing”. The determination method is the same as conventional determination methods. An example of the determination method is discussed below.

As described earlier, every time when touch panel coordinates P are input, the touch event receiving portion 101 detects, as the touch event, any one of the press, keep, and release, and calculates display surface coordinates Q. The touch response processing determination portion 103 determines processing in accordance with the display surface coordinates Q calculated and the touch event detected.

For example, if an object on the display surface coordinates Q is the close button 4A of the copy job screen 3C shown in FIG. 6, and if the touch event is determined to be a press, then the touch response processing determination portion 103 determines that the touch response processing is processing of changing the style of the close button 4A (e.g., changing the color thereof to gray, or, changing the shape thereof to a concave shape). After that, if the touch event of release is made in any position of the close button 4A, then the touch response processing determination portion 103 determines that the touch response processing is processing correlated, in advance, with the close button 4A, i.e., processing of closing the copy job screen 3C to display the immediately preceding screen.

Alternatively, if an object on the display surface coordinates Q is the right scroll button 4B1 of the copy job screen 3C, and if the touch event is determined to be a press or keep, then the touch response processing determination portion 103 determines that the touch response processing is processing of scrolling across the icon row 4L from right to left.

On the other hand, when the element region where the display surface coordinates Q are located is determined to be a gesture region, the gesture determination portion 104 and the gesture response processing determination portion 105 perform the following processing.

Based on the touch events successively detected by the touch event receiving portion 101 and on the display surface coordinates Q for each of the touch events, the gesture determination portion 104 determines a gesture represented by the series of the touch events. The determination method is the same as conventional determination methods. An example of the determination method is discussed below.

For example, if combined operation of a press, keep, and release is detected twice on the identical display surface coordinates Q within a predetermined time Tb (0.5 sec. for example), then the gesture determination portion 104 determines that the gesture is a double-tap. Alternatively, if combined operation of a press, keep, and release is detected once on the identical display surface coordinates Q, and if no touch event is detected on the identical display surface coordinates Q within the next predetermined time Tb, then the gesture determination portion 104 determines that the gesture is a tap.

Quick operation sometimes does not allow a keep to be detected properly. In light of this, even if combined operation of a press and release is detected instead of the combined operation of a press, keep, and release, the determination is made in the same manner as that described above. If the number of consecutive “keep” is greater than a predetermined number of times, then the gesture determination portion 104 may determine that such a gesture is not a tap but a long tap. If the distance between two display surface coordinates Q falls within a predetermined range, then the gesture determination portion 104 may regard the two display surface coordinates Q as the identical display surface coordinates Q.

Alternatively, after the detection of a press, if a keep is detected while display surface coordinates Q move unidirectionally at a speed greater than a predetermined speed Sa, and if a release is detected, then the gesture determination portion 104 determines that such a gesture is a flick. At this time, as a condition value 5C, the speed and direction at/in which the display surface coordinates Q move are also calculated.

Yet alternatively, after the detection of a press, if a keep is detected while display surface coordinates Q move at a speed smaller than the predetermined speed Sa, then the gesture determination portion 104 determines that such a gesture is a drag. At this time, as the condition value 5C, a locus of the display surface coordinates Q (coordinates for each time) are also obtained. If operation not related to a drag is performed before a release, it is possible to regard the drag as having been cancelled. For example, if a touch is made at a position away from the locus of the display surface coordinates Q before the release, it is possible to regard the drag as having been cancelled.

The gesture response processing determination portion 105 determines processing to be executed in response to the gesture made by the user. Hereinafter, the processing is referred to as “gesture response processing”. The determination method is the same as conventional determination methods. An example of the determination method is discussed below.

For example, if the user flicks any of the optional function icons 4C of the copy job screen 3C of FIG. 6, then the gesture response processing determination portion 105 determines that the gesture response processing is processing of scrolling across the icon row 4L in accordance with the condition value 5C (indicating the speed and direction at/in which the display surface coordinates Q move).

If the user double-taps an optional function icon 4Cs, then the gesture response processing determination portion 105 determines that the gesture response processing is processing of changing the style of the optional function icon 4Cs so as to indicate “ON”, and of updating the set value of watermark application to be ON.

Every time a key (hardware key) is pressed, the hardware key panel 10k1 outputs a pressed key signal 5D indicating the pressed key to the main CPU 10a. In response to the output, the hardware key operation receiving portion 106 and the hardware key response processing determination portion 107 perform the following processing.

The hardware key operation receiving portion 106 receives the pressed key signal 5D. The hardware key response processing determination portion 107 determines, based on the current screen and the pressed key signal 5D, processing to be executed in response to the operation performed by the user on the hardware key panel 10k1. Hereinafter, the processing is referred to as “hardware key response processing”. The determination method is the same as conventional determination methods. An example of the determination method is discussed below.

For example, if the user presses the function key 1kf1 (see FIG. 4) while any screen is displayed, then the hardware key response processing determination portion 107 determines that the hardware key response processing is processing of displaying the fax transmission job screen 3F as that shown in FIG. 11A.

Alternatively, if the user enters facsimile number with the numeric keys 1kt while the fax transmission job screen 3F is displayed as the current screen, then the hardware key response processing determination portion 107 determines that the hardware key response processing is processing of receiving the facsimile number as a transmission destination and reflecting the facsimile number in the fax transmission job screen 3F as shown in FIG. 11B.

Every time when the touch response processing determination portion 103 determines the touch response processing, every time when the gesture response processing determination portion 105 determines the gesture response processing, or every time when the hardware key response processing determination portion 107 determines the hardware key response processing, the screen control portion 108 controls the individual pieces of hardware in such a manner that the determined touch response processing, gesture response processing, or hardware key response processing is executed, respectively. Hereinafter, the touch response processing, the gesture response processing, and the hardware key response processing are collectively called “response processing”.

The response processing can be performed via an Application Program Interface (API) as with conventional methods.

[Processing for Making Record of Operation]

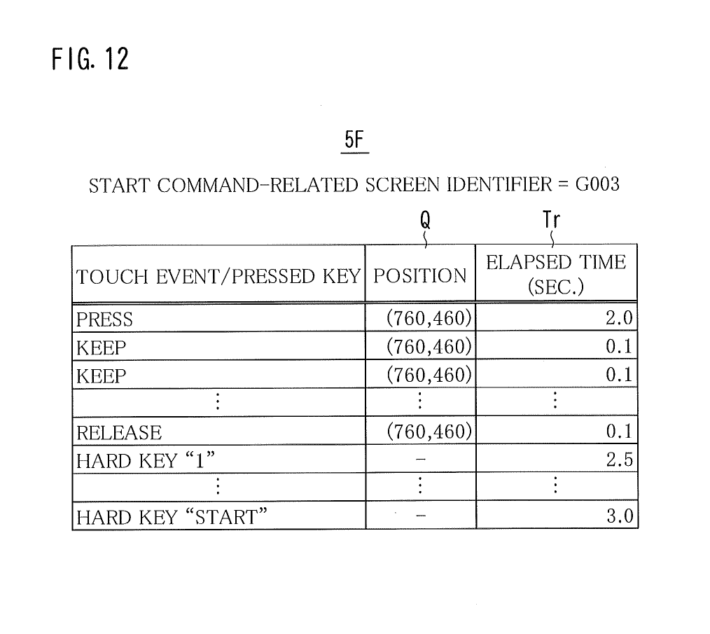

FIG. 12 is a diagram showing an example of operation log data 5F.

When the user enters a command to start making a record of operation (hereinafter, referred to as a “start command”), the operation log data generating portion 121 and the operation log data storage portion 122 of FIG. 8 perform processing for making a record of a log of operation performed on the operating panel unit 10k in the following manner.

The user displays, on the liquid crystal display 10k2, a screen for performing the initial operation of a series of operation to be reproduced later. The user then enters the start command to start the series of operation.

As with the normal mode, the touch event receiving portion 101 through the screen control portion 108 perform the processing according to the series of operation in the foregoing manner. In particular, every time the touch panel coordinates P are detected by the touch panel 10k3, the touch event receiving portion 101 calculates the display surface coordinates Q. Further, every time the touch panel coordinates P are detected, and when the detection of the touch panel coordinates P stops, the touch event receiving portion 101 determines a touch event. The hardware key operation receiving portion 106 receives the pressed key signal 5D from the hardware key panel 10k1.

The operation log data generating portion 121 generates the operation log data 5F as shown in FIG. 12 to store the same into the operation log data storage portion 122.

The operation log data 5F indicates touch events detected by the touch event receiving portion 101, display surface coordinates Q calculated by the touch event receiving portion 101, and the pressed key signals 5D received by the hardware key operation receiving portion 106 during a period between the entry of the start command and the entry of a command to finish making a record of operation (hereinafter, referred to as an “end command”). Further, the operation log data 5F also indicates elapsed time Tr from when the previous (immediately preceding) touch event or pressed key signal 5D was detected or received to when each touch event and each pressed key signal 5D is detected or received. As the elapsed time Tr for the foremost touch event or pressed key signal 5D, the elapsed time since the start command has been entered is indicated.

As the end command is entered, the operation log data generating portion 121 finishes the processing for generating the operation log data 5F. The operation log data 5F is given an identifier of a screen that was displayed on the liquid crystal display 10k2 at the time when the start command was entered. Such an identifier is hereinafter referred to as a “start command-related screen identifier”.

[Processing for Reproducing Operation]

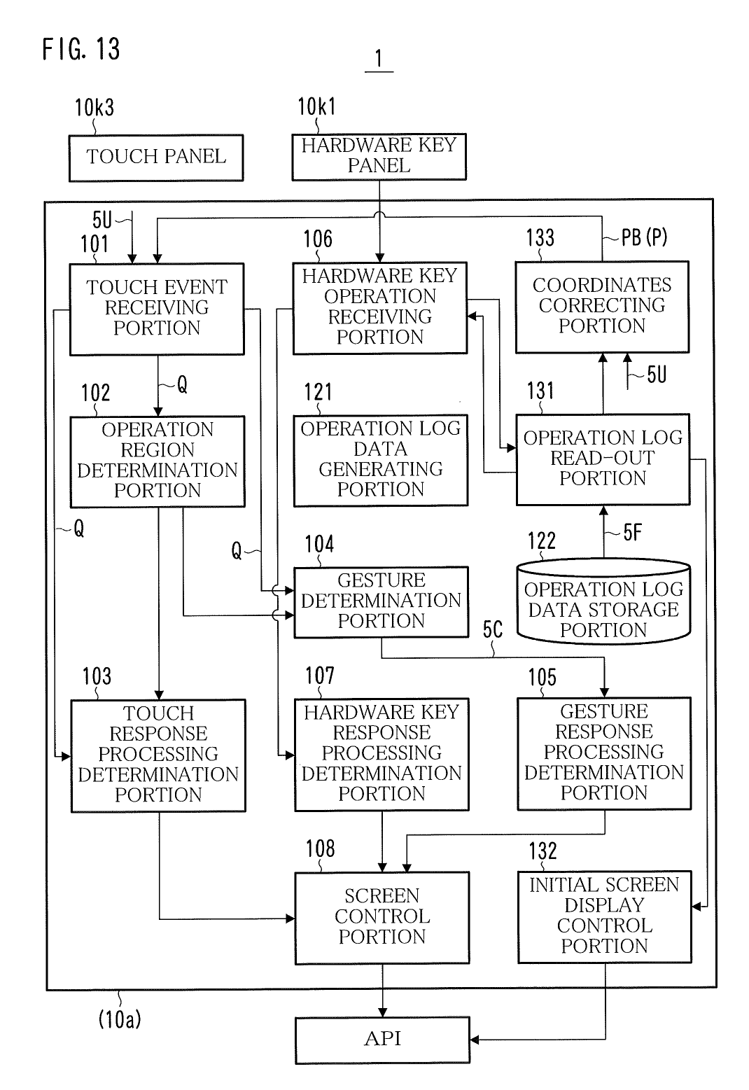

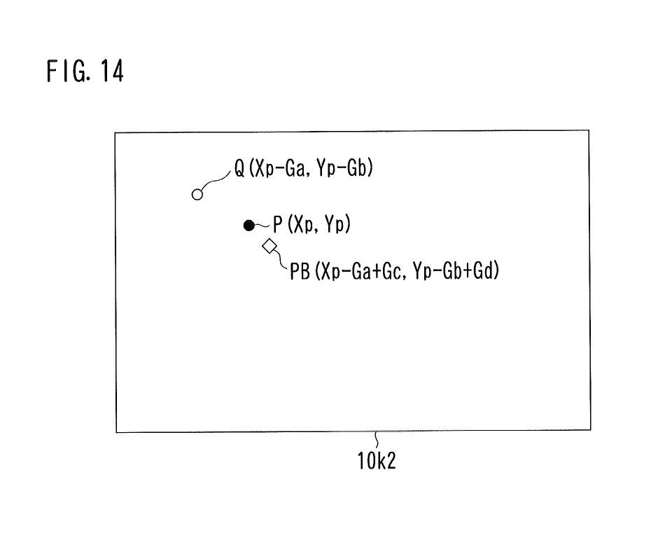

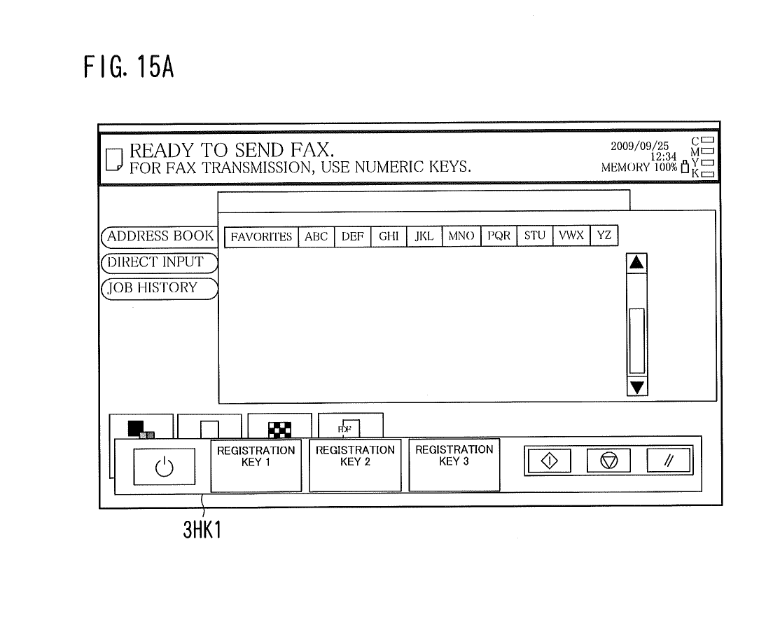

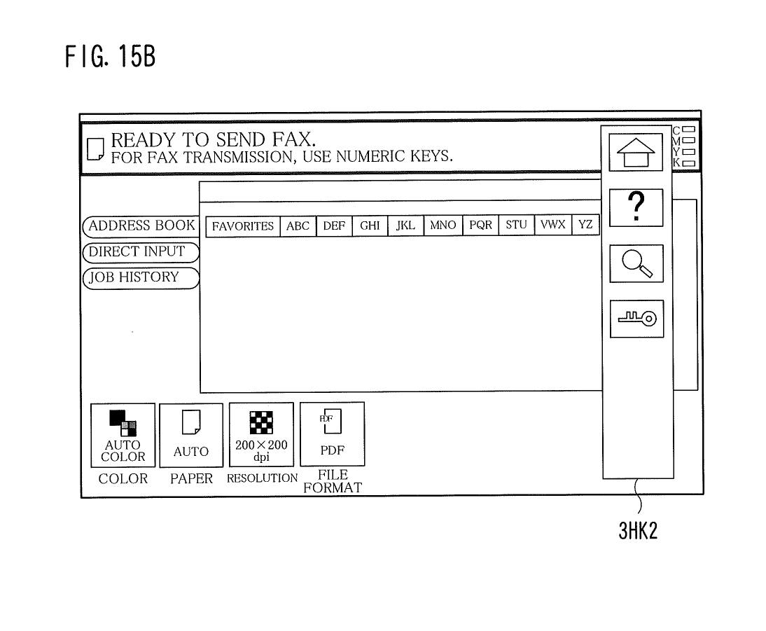

FIG. 13 is a diagram showing an example of the functional configuration of the image forming apparatus 1 and the flow of data in reproducing operation. FIG. 14 is a diagram showing an example of the positional relationship among the touch panel coordinates P, the display surface coordinates Q, and the touch panel coordinates PB. FIGS. 15A and 15B are diagrams showing an example of a hardware key panel lower screen 3HK1 and a hardware key panel right screen 3HK2, respectively.

The operation log read-out portion 131, the initial screen display control portion 132, and the coordinates correcting portion 133 work in coordination with the operation region determination portion 102 through the screen control portion 108 to perform processing for reproducing a series of operation that was performed by the user. Even if the series of operation was performed by the user on another image forming apparatus 1, such reproduction processing can be performed.

Hereinafter, the processing by the individual portions are described with reference to FIG. 13 by taking an example in which a series of operation that was performed by the user on the image forming apparatus 1A is reproduced in the image forming apparatus 1B.

The operation log data 5F recorded in the operation log data storage portion 122 of the image forming apparatus 1A is copied, in advance, into an operation log data storage portion 122 of the image forming apparatus 1B via the communication line NW or a portable recording medium.

With the image forming apparatus 1B, when the user enters a command to reproduce operation (hereinafter, referred to as a “reproduction command”), an operation log read-out portion 131 switches the mode of the image forming apparatus 1B from the normal mode to the reproduction mode, and reads out the operation log data 5F from the operation log data storage portion 122. Then, the operation log read-out portion 131 conveys the start command-related screen identifier given to the operation log data 5F to an initial screen display control portion 132.

In response to this operation, the initial screen display control portion 132 controls a liquid crystal display 10k2 so as to display a screen corresponding to the start command-related screen identifier.

A coordinates correcting portion 133 converts display surface coordinates Q shown in the individual records of the operation log data 5F into coordinates corresponding to a touch panel 10k3 of the image forming apparatus 1B based on the correction amount data 5U of the image forming apparatus 1B. Such corresponding coordinates are hereinafter referred to as “touch panel coordinates PB” or “touch panel coordinates PB (Xpb, Ypb). To be specific, the touch panel coordinates PB are calculated based on the following equation (1) below.

Touch panel coordinates PB(Xpb,Ypb)=display surface coordinates Q(Xq,Yq)+(Gc,Gd) (1)

The touch panel coordinates PB are represented, as (Xp−Ga+Gc, Yp−Gb+Gd) as shown in FIG. 14, by using the touch panel coordinates P in the image forming apparatus 1A.

The coordinates correcting portion 133 gives, to the touch event receiving portion 101, the touch panel coordinates PB instead of the touch panel coordinates P detected by the touch panel 10k3. The touch panel coordinates PB are given at a time in accordance with the elapsed time Tr of each record. To be specific, the touch panel coordinates PB calculated based on the foremost record are given at a time when the elapsed time Tr indicated in the foremost record has passed since a reproduction command was entered. The touch panel coordinates PB calculated based on the N-th (N≧2) record are given at a time when the elapsed time Tr indicated in the N-th record has passed since the touch panel coordinates PB calculated based on the (N−1)-th record were given.

When the coordinates correcting portion 133 gives the touch panel coordinates PB to the touch event receiving portion 101, the touch event receiving portion 101, the operation region determination portion 102, the touch response processing determination portion 103, the gesture determination portion 104, the gesture response processing determination portion 105, and the screen control portion 108 perform processing, as with the case of the normal mode, by using the touch panel coordinates PB instead of the touch panel coordinates P.

If the record indicates the pressed key signal 5D, then the pressed key signal 5D is given to the hardware key operation receiving portion 106 without being passed through the coordinates correcting portion 133.

In response to the receipt of the pressed key signal 5D, the hardware key operation receiving portion 106 and the hardware key response processing determination portion 107 perform processing, as with the case of the normal mode, based on the pressed key signal 5D.

In this way, the reproduction of operation based on the operation log data 5F causes screen transition. The user can presume what kind of operation was made by looking at the screen transition.

For the sake of further easy presumption by the user, the screen control portion 108 may display a mark representing the display surface coordinates Q on the screen. For example, a mark representing some or all of the display surface coordinates Q for a flick may be displayed as the lotus. This enables the user to presume the magnitude of the flick easily.

Alternatively, it is possible to change the style of the mark representing the display surface coordinates Q in accordance with a gesture determined by the gesture determination portion 104. For example, for the case of flick, the screen control portion 108 displays, as the mark representing the display surface coordinates Q, a perfect circle drawn by a heavy line. For the case of drag, a triangle drawn by a dotted line is displayed as the mark representing the display surface coordinates Q.

Even if operation on the hardware key panel 10k1 is reproduced, the user sometimes cannot presume which key was pressed. To cope with this, the screen control portion 108 may display an image of the hardware key panel 10k1 on the screen to display a mark on the pressed key. Instead of displaying the entire image of the hardware key panel 10k1, a partial image thereof may be displayed. The hardware key panel 10k1 may be displayed only when operation on the hardware key panel 10k1 is reproduced, instead of being always displayed.

For example, during a predetermined period including a point in time when the function key 1kf1 is touched, the screen control portion 108 displays the hardware key panel lower screen 3HK1 showing a lower part of the hardware key panel 10k1 as shown in FIG. 15A. Then, a predetermined mark (star mark, for example) is displayed on the image of the function key 1kf1. Likewise, if the operation log data 5F shows the function key 1kf4, then the screen control portion 108 displays the hardware key panel right screen 3HK2 as shown in FIG. 15B. Then, the predetermined mark is displayed on the image of the function key 1kf4.

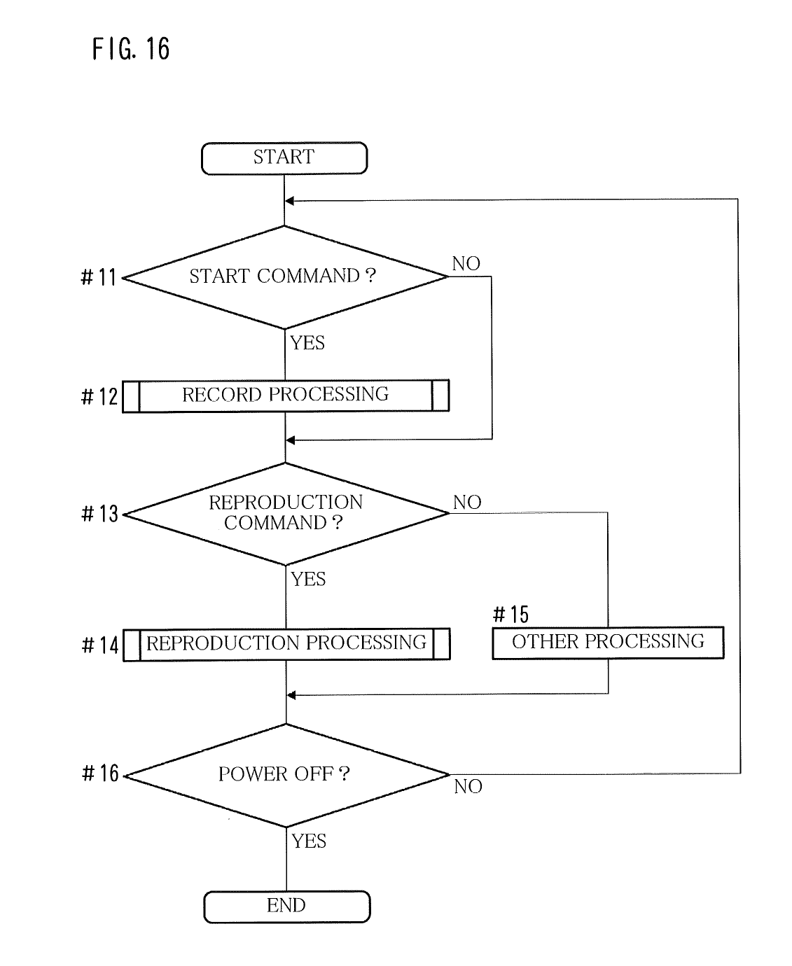

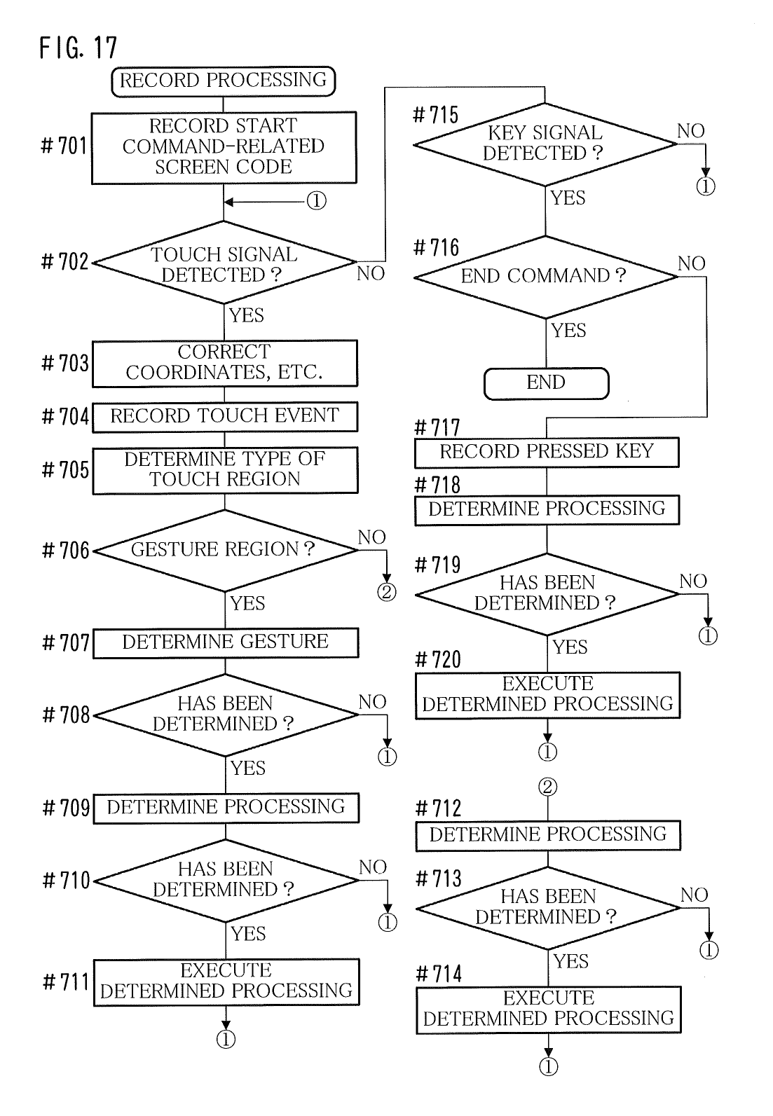

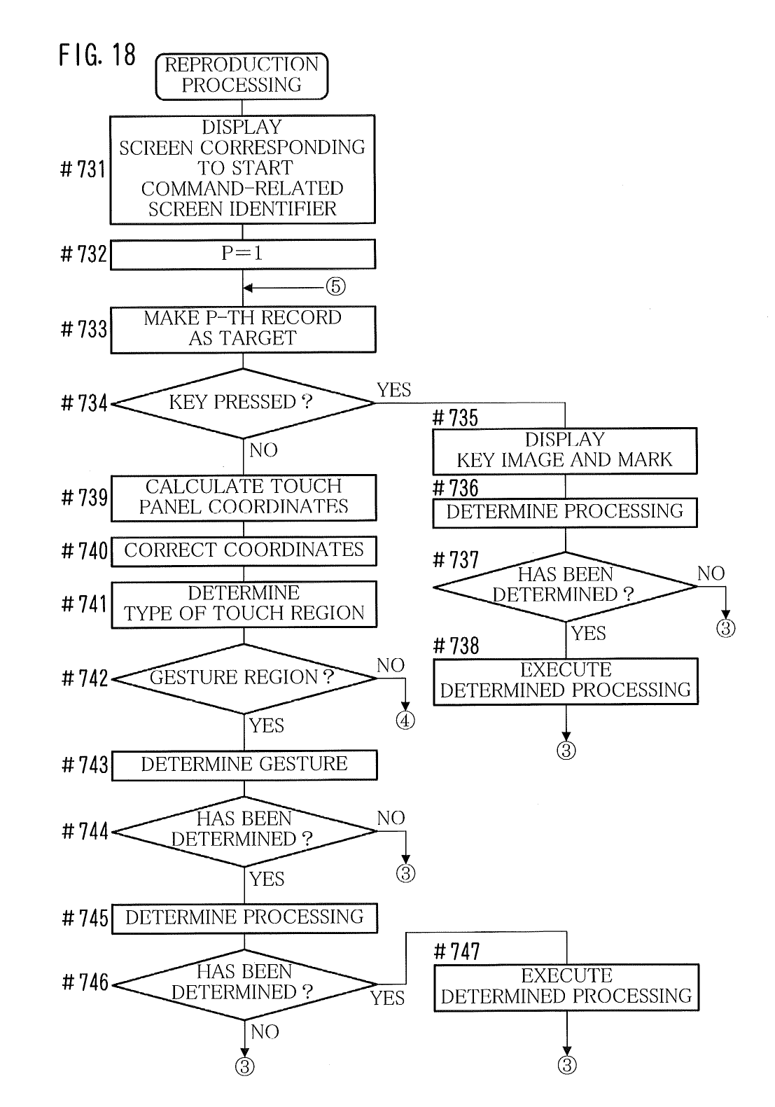

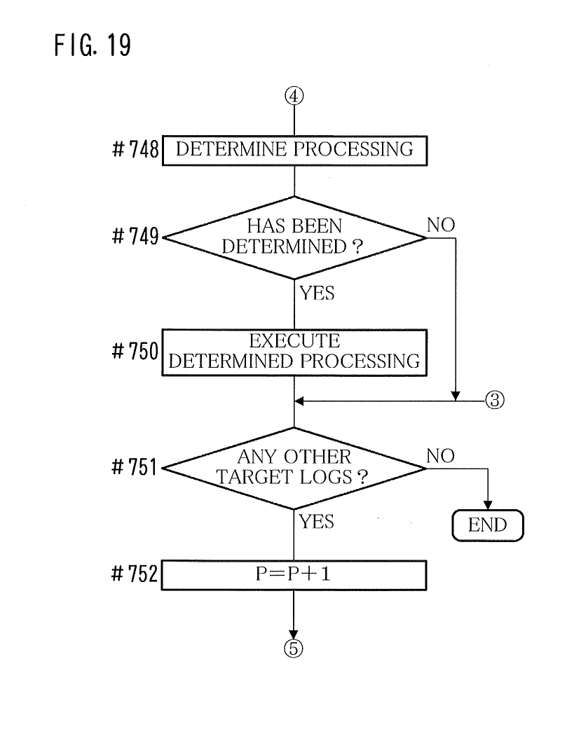

FIG. 16 is a flowchart depicting an example of the flow of the entire processing performed by the image forming apparatus 1. FIG. 17 is a flowchart depicting an example of the flow of record processing. FIGS. 18 and 19 are flowcharts depicting an example of the flow of reproduction processing.

The description goes on to the flow of the entire processing related to display in the image forming apparatus 1 with reference to the flowcharts of FIGS. 16-19.

While being ON, the image forming apparatus 1 performs processing as shown in FIG. 16 in accordance with operation by the user on the operating panel unit 10k.

To be specific, when a start command is entered (YES in Step #11), the image forming apparatus 1 performs processing for making a record of operation logs in the steps as depicted in FIG. 17 (Step #12).

Referring to FIG. 17, the image forming apparatus 1 generates empty operation log data 5F to correlate the empty operation log data 5F with a start command-related screen identifier of the current screen (Step #701).

If detecting touch panel coordinates P through the touch panel 10k3 (YES in Step #702), then the image forming apparatus 1 corrects the touch panel coordinates P to calculate display surface coordinates Q and determine the touch event (Step #703), and makes one record including the pieces of information and the elapsed time Tr to add the record to the operation log data 5F (Step #704). The image forming apparatus 1 then determines the type of a region within which the display surface coordinates Q are located, namely, determines whether the region is a simple operation region or a gesture region (Step #705).

If the region is determined to be a gesture region (YES in Step #706), then the image forming apparatus 1 attempts to determine what kind of gesture was made by the user (Step #707). As the gesture is represented by a combination of touches, the gesture sometimes cannot be determined at this point in time. If determining the kind of the gesture (YES in Step #708), then the image forming apparatus 1 attempts to determine processing to be executed in response to the gesture (Step #709). If determining the processing to be executed (YES in Step #710), then the image forming apparatus 1 executes the processing (Step #711).

On the other hand, if the region is determined to be a simple operation region (NO in Step #706), then the image forming apparatus 1 attempts to determine processing to be executed in response to the touch event (Step #712). If determining the processing to be executed (YES in Step #713), then the image forming apparatus 1 executes the processing (Step #714).

Alternatively, if the image forming apparatus 1 receives a pressed key signal 5D through the hardware key panel 10k1 (NO in Step #702, and YES in Step #715), and if the pressed key signal 5D indicates no start/end command key 1kf2 (NO in Step #716), then the image forming apparatus 1 makes one record including the pressed key signal 5D and the elapsed time Tr, and adds the record to the operation log data 5F (Step #717). The image forming apparatus 1 then attempts to determine processing to be executed in response to the pressed key (Step #718). If determining the processing to be executed (YES in Step #719), then the image forming apparatus 1 executes the processing (Step #720).

The image forming apparatus 1 performs the processing of Step #702 through Step #720 appropriately until the start/end command key 1kf2 is pressed.

When receiving a pressed key signal 5D indicating the start/end command key 1kf2 (YES in Step #716), the image forming apparatus 1 finishes the processing for making a record of operation logs.

Referring back to FIG. 16, when a reproduction command is entered (Yes in Step #13), the image forming apparatus 1 performs processing for reproducing user operation based on the operation log data 5F in the steps as depicted in FIGS. 18 and 19 (Step #14).

The image forming apparatus 1 reads out the operation log data 5F to display a screen corresponding to the start command-related screen identifier correlated with the operation log data 5F (Step #731 of FIG. 18). The operation log data 5F may be generated by the subject image forming apparatus 1 or obtained from another image forming apparatus 1.

The image forming apparatus 1 makes, as a target, the topmost record of the operation log data 5F (Step #732 and Step #733).

If the target record indicates a pressed key signal 5D (YES in Step #734), then the image forming apparatus 1 displays, as exemplified in FIG. 15, the image of the hardware key panel 10k1 on the current screen and displays a mark on a key indicated in the pressed key signal 5D (Step #735). The image forming apparatus 1 then attempts to determine processing to be executed in response to the pressed key (Step #736). If determining the processing to be executed (Yes in Step #737), then the image forming apparatus 1 executes the processing (Step #738).

On the other hand, if the target record indicates display surface coordinates Q, a touch event, and an elapsed time Tr (NO in Step #734), then the image forming apparatus 1 corrects the display surface coordinates Q based on the correction amount data 5U to calculate touch panel coordinates P on the touch panel 10k3 of the subject image forming apparatus 1 (Step #739). The image forming apparatus 1 then performs processing based on the touch panel coordinates P as with the case of the normal mode.

To be specific, the image forming apparatus 1 converts the calculated touch panel coordinates P into the display surface coordinates Q (Step #740), and determines the type of a region in which the display surface coordinates Q are located (Step #741).

If the region is determined to be a gesture region (YES in Step #742), then the image forming apparatus 1 attempts to determine the kind of gesture (Step #743). If determining the kind of gesture (YES in Step #744), then the image forming apparatus 1 attempts to determine processing to be executed in response to the gesture (Step #745). If determining the processing to be executed (YES in Step #746), then the image forming apparatus 1 executes the processing (Step #747).

If the region is determined to be a simple operation region (NO in Step #742), then the image forming apparatus 1 attempts to determine processing to be executed in response to the touch event (Step #748). If determining the processing to be executed (YES in Step #749), then the image forming apparatus 1 executes the processing (Step #750).

If the operation log data 5F has records that have not yet been regarded as targets (YES in Step #751), then the processing goes back to Step #733 in which the image forming apparatus 1 makes, among the records having not yet been regarded as targets, the topmost record as a target to execute the processing appropriately from Step #734 through Step #750.

Referring back to FIG. 16, when a command other than the operation record command and operation reproduction command is entered (NO in Step #13), the image forming apparatus 1 performs processing based on the entered command as per the conventional art (Step #15).

The description goes on to operation, processing, and screen transition for a case where the image forming apparatus 1A generates operation log data 5F, and the image forming apparatus 1B uses the operation log data 5F. The description takes an example where a binding margin of a copy is set at “left binding”.

[At Time of Generating Operation Log Data]

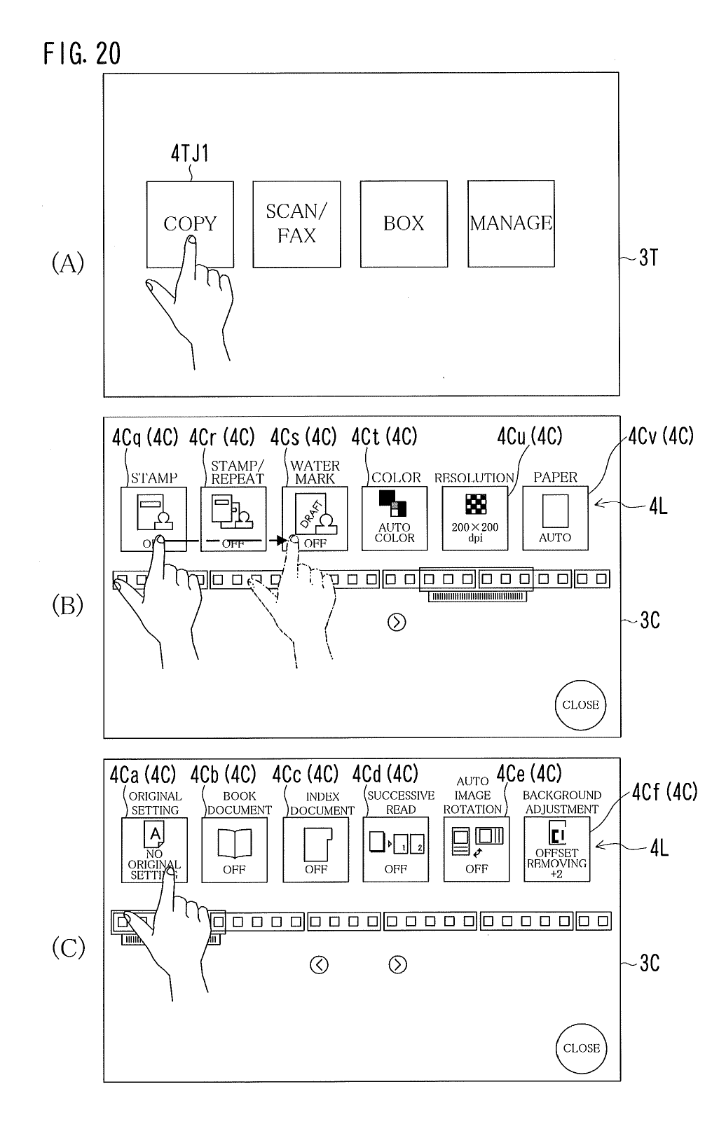

FIGS. 20-22 show examples of screen transition and user operation for the case where operation log data is generated.

A creator of an operation manual enters a start command by pressing the start/end command key 1kf2 (see FIG. 4) of the image forming apparatus 1A while the home screen 3T in (A) of FIG. 20 is displayed. The entirety of the home screen 3T corresponds to a simple operation region.

In response to entry of the start command, the image forming apparatus 1A starts making a record of operation on the hardware key panel 10k1 or the touch panel 10k3. How to make such a record is the same as that described earlier with reference to FIG. 17. In this example, the image forming apparatus 1A first prepares empty operation log data 5F, and then, writes the content of operation into the empty operation log data 5F in due order.

The creator taps a copy button 4TJ1 in the home screen 3T. In response to this operation, the image forming apparatus 1A adds, to the operation log data 5F, a record for each predetermined time while the creator taps (touches) the copy button 4TJ1. The home screen 3T is then replaced with the copy job screen 3C as shown in (B) of FIG. 20.

The creator flicks the icon row 4L from left to right. The image forming apparatus 1A adds, to the operation log data 5F, a record for each predetermined time while the creator flicks the icon row 4L. The creator further scrolls across the icon row 4L. Thereby, the icon row 4L changes as shown in (C) of FIG. 20.

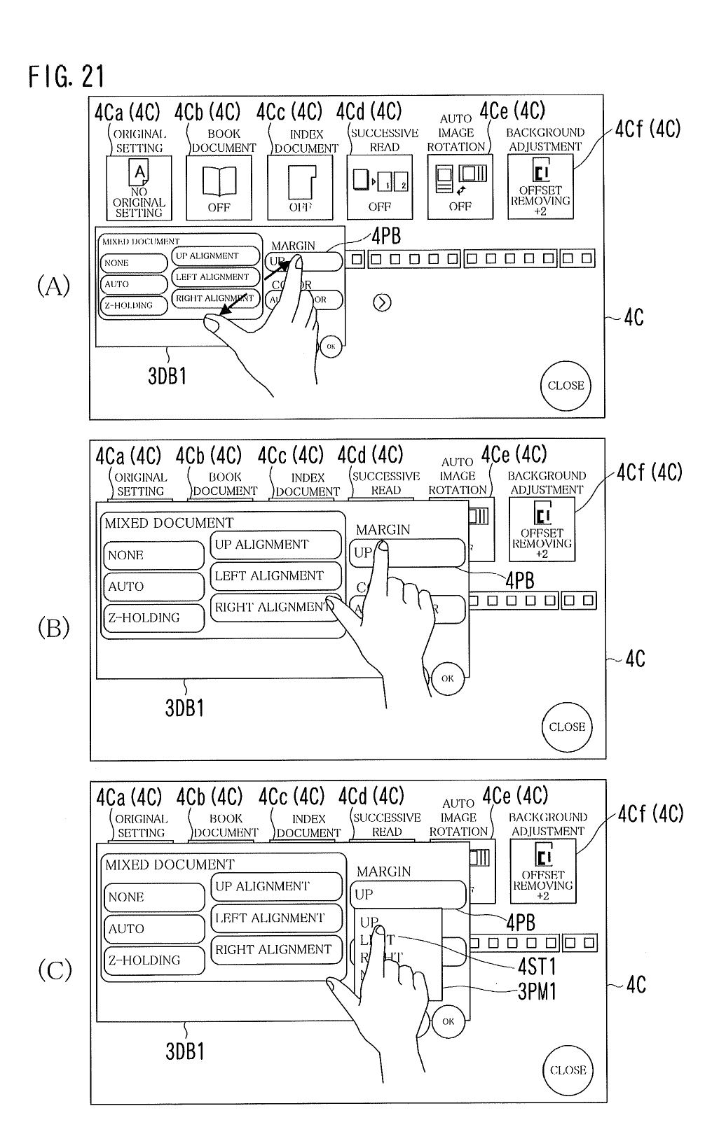

The creator double-taps the optional function icon 4Ca. In response to the double-tap, the image forming apparatus 1A adds a record 5Fc indicating the double-tap to the operation log data 5F. The image forming apparatus 1A then displays a dialog box 3DB1 on the copy job screen 3C as shown in (A) of FIG. 21.

In order to make the dialog box 3DB1 more visible, the creator pinches any position of the dialog box 3DB1. In response to the pinch, the image forming apparatus 1A adds, to the operation log data 5F, a record for each predetermined time while the creator pinches the dialog box 3DB1. The image forming apparatus 1A further enlarges the dialog box 3DB1 as shown in (B) of FIG. 21. The entirety of the dialog box 3DB1 corresponds to a gesture region.

The creator taps a pull-down button 4PB. In response to the tap, the image forming apparatus 1A adds, to the operation log data 5F, a record for each predetermined time while the creator taps the pull-down button 4PB. The image forming apparatus 1A further displays a pull-down menu 3PM1 on the dialog box 3DB1 as shown in (C) of FIG. 21.

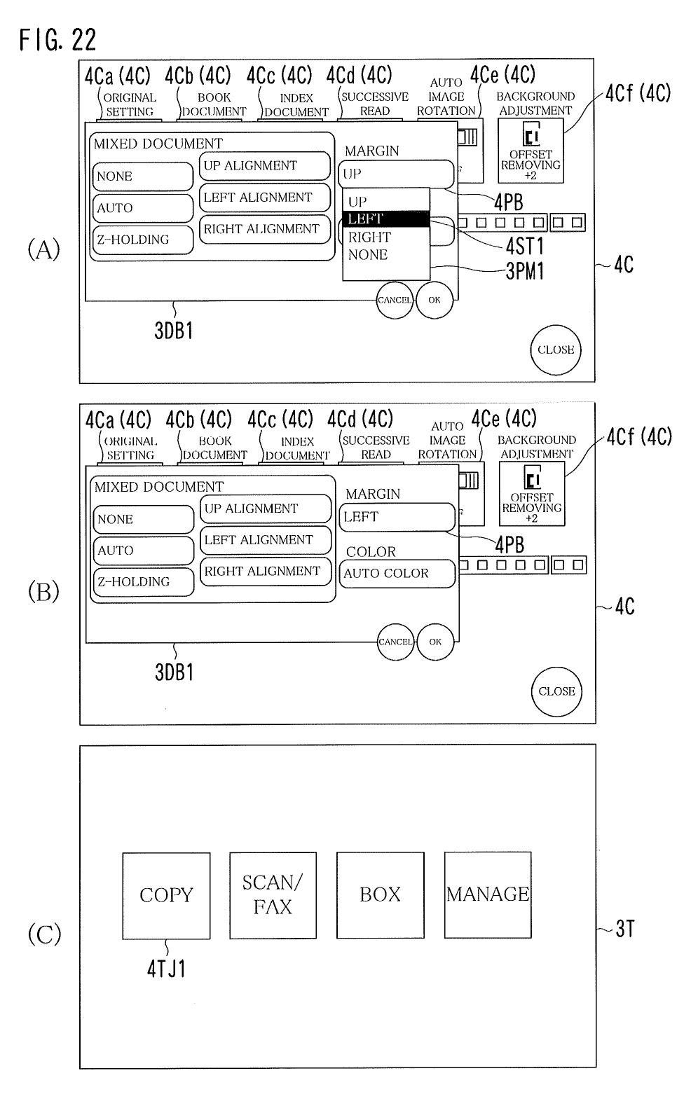

The creator taps an option 4ST1 corresponding to “left binding” in the pull-down menu 3PM1. In response to the tap, the image forming apparatus 1A adds, to the operation log data 5F, a record for each predetermined time while the creator taps the option 4ST1. The image forming apparatus 1A further changes the style of the option 4ST1 to a style indicating that the option 4ST1 is currently selected, for example, to a style in which the character color and the background color are inverted from each other as shown in (A) of FIG. 22. When a predetermined time (0.5 seconds, for example) has elapsed since the creator finished the tap, the pull-down menu 3PM1 is closed and the binding margin of a copy is set at “left binding” as shown in (B) of FIG. 22.

The creator presses the function key 1kf4 of the hardware key panel 10k1. The function key 1kf4 is to return to the home screen 3T. The image forming apparatus 1A adds a record indicating that the function key 1kf4 was pressed to the operation log data 5F. The image forming apparatus 1A closes the copy job screen 3C to display the home screen 3T again as shown in (C) of FIG. 22.

The creator enters an end command by pressing the start/end command key 1kf2. In response to entry of the end command, the image forming apparatus 1A finishes the record processing. The image forming apparatus 1A correlates, with the operation log data 5F, an identifier of the current screen at the time when the start command was entered, i.e., an identifier of the home screen 3T, as the start command-related screen identifier.

Through the foregoing operation and processing, making a record of operation, i.e., generating operation log data 5F, is completed.

The creator then copies the operation log data 5F onto a portable recording medium to convey the same to a service engineer.

[At Time of Reproducing Operation]

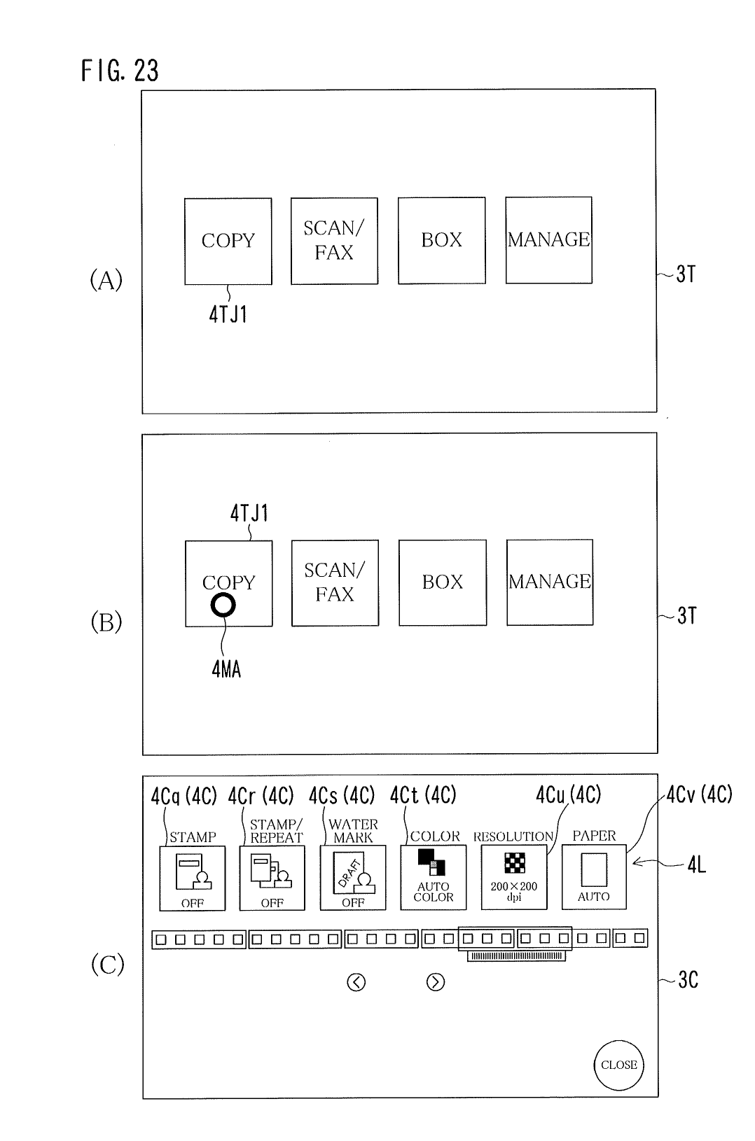

FIGS. 23-26 show examples of screen transition for the case where operation is reproduced.

The service engineer sets the portable recording medium in the image forming apparatus 1B to copy the operation log data 5F into the operation log data storage portion 122. The service engineer then enters a reproduction command. In response to entry of the reproduction command, the image forming apparatus 1B performs processing based on the records of the operation log data 5F in the following manner.

The image forming apparatus 1B displays a home screen 3T as shown in (A) of FIG. 23 in accordance with the start command-related screen identifier correlated with the operation log data 5F. The image forming apparatus 1B displays a mark 4MA representing a tap on a copy button 4TJ1 as shown in (B) of FIG. 23. The image forming apparatus 1B then replaces the home screen 3T with a copy job screen 3C as shown in (C) of FIG. 23.

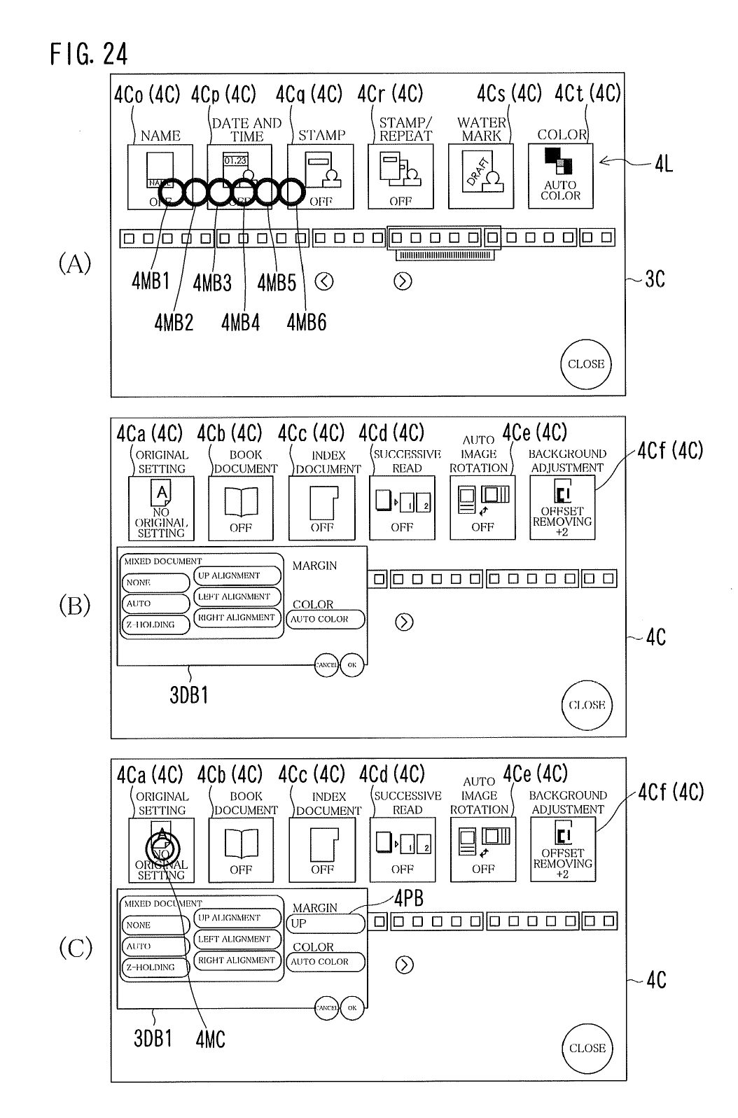

The image forming apparatus 1B scrolls across the icon row 4L with marks 4MB1-4MB6 corresponding to the flicked positions displayed as shown in (A) of FIG. 24.

When finishing scrolling across the icon row 4L as shown in (B) of FIG. 24, the image forming apparatus 1B displays a mark 4MC corresponding to a double-tap on the optional function icon 4Ca, and displays a dialog box 3DB1 on the copy job screen 3C as shown in (C) of FIG. 24.

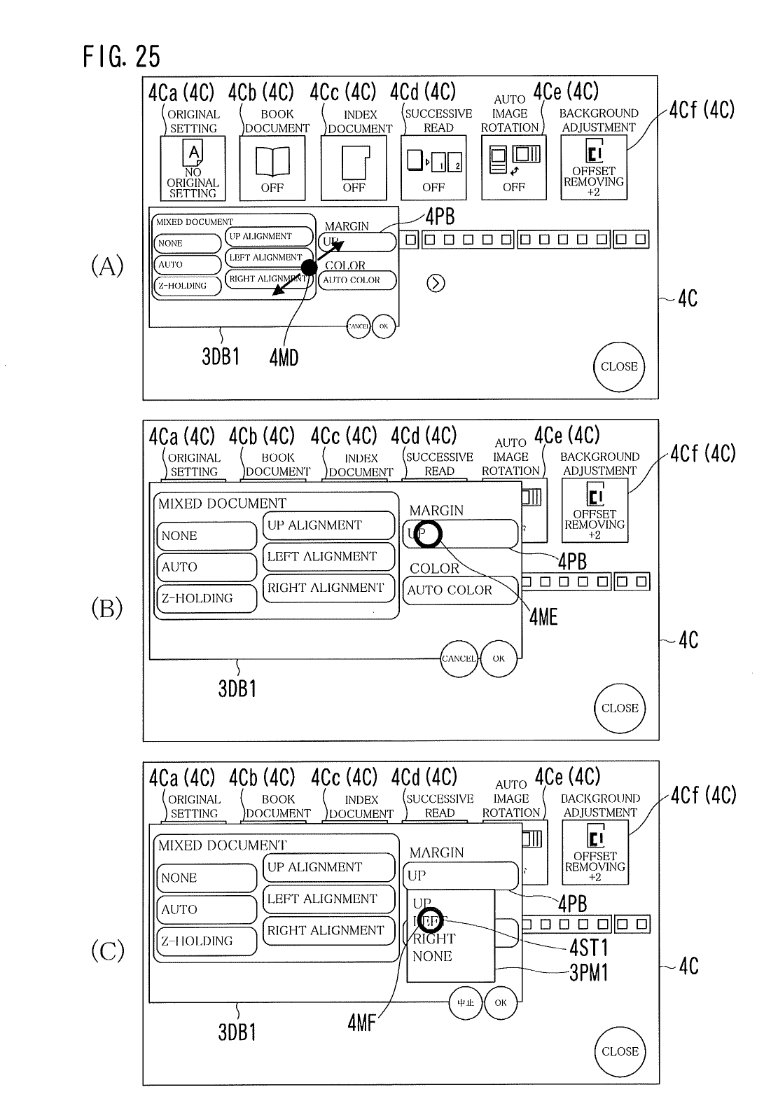

The image forming apparatus 1B displays a mark 4MD corresponding to the start position and direction of a pinch as shown in (A) of FIG. 25, and starts enlarging the dialog box 3DB1.

When finishing enlarging the dialog box 3DB1 as shown in (B) of FIG. 25, the image forming apparatus 1B displays a mark 4ME representing a tap on the pull-down button 4PB, and displays the pull-down menu 3PM1 as shown in (C) of FIG. 25.

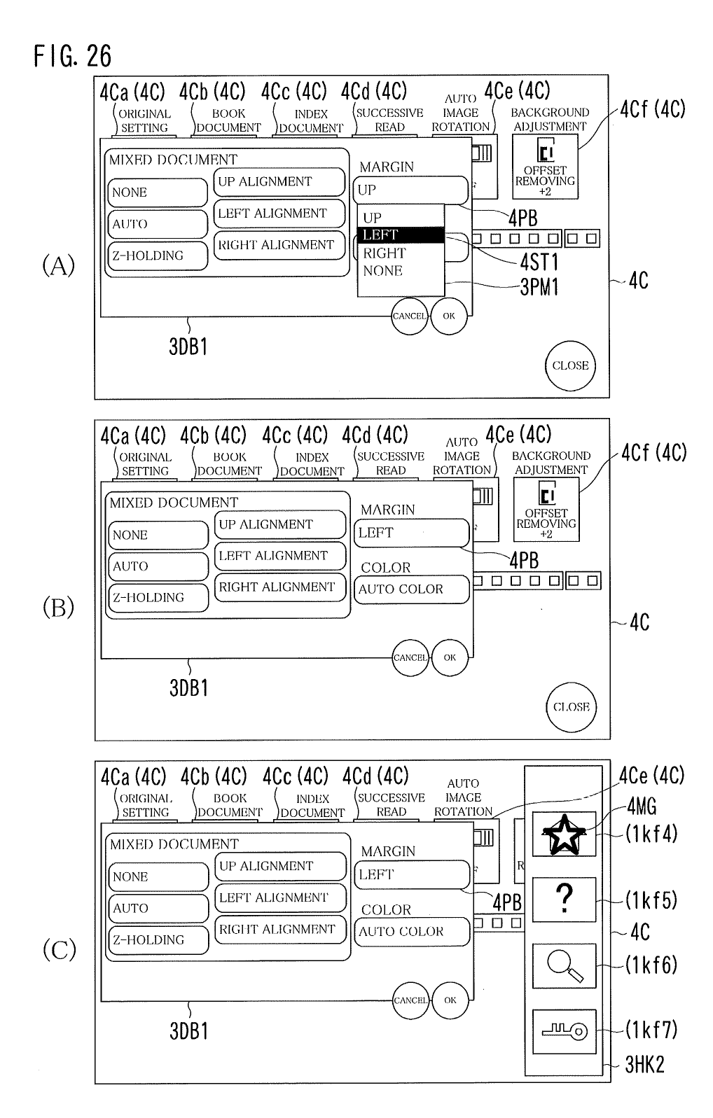

The image forming apparatus 1B displays a mark 4MF corresponding to a tap on the option 4ST1. The image forming apparatus 1B changes the style of the option 4ST1 to a style as shown in (A) of FIG. 26, and then closes the pull-down menu 3PM1 as shown in (B) of FIG. 26.

The image forming apparatus 1B displays the hardware key panel right screen 3HK2 on the copy job screen 3C as shown in (C) of FIG. 26 and displays a mark 4MG representing “pressed” on an image of the function key 1kf4. The image forming apparatus 1B closes the hardware key panel right screen 3HK2 and displays the home screen 3T (see (A) of FIG. 23) again instead of the copy job screen 3C.

In this embodiment, even when the touch panel displays differ from one another in property, in particular, even when the touch panel displays differ from one another in position at which a touch panel is laid on the display surface of a display, operation by a user can be performed more accurately than with conventionally possible.

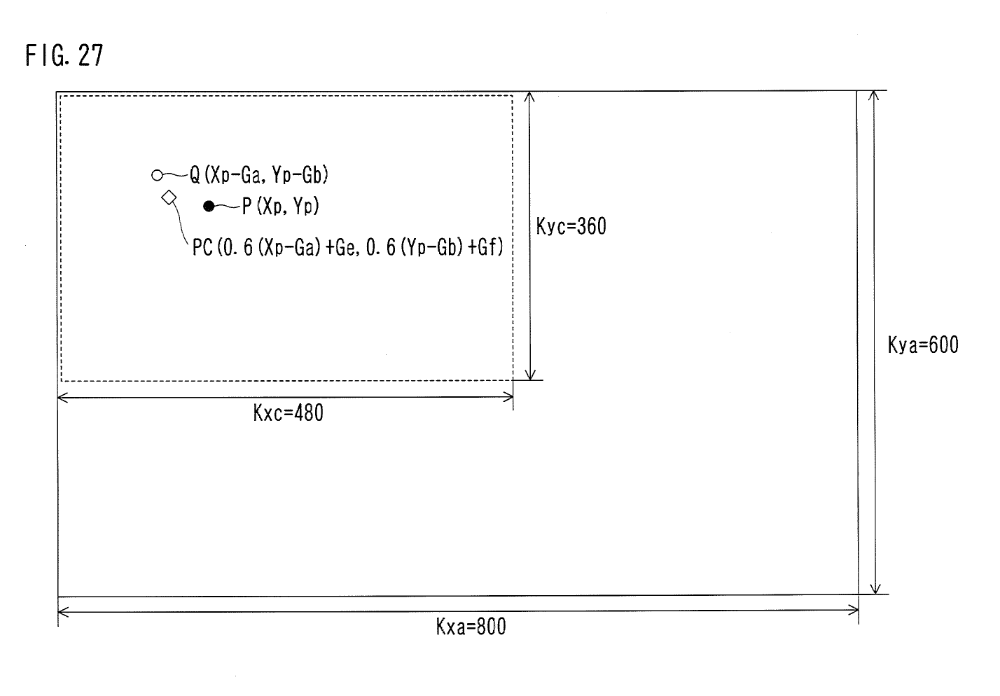

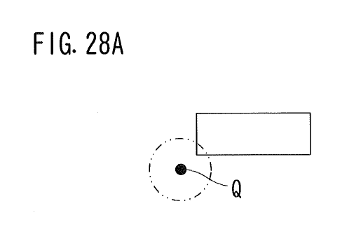

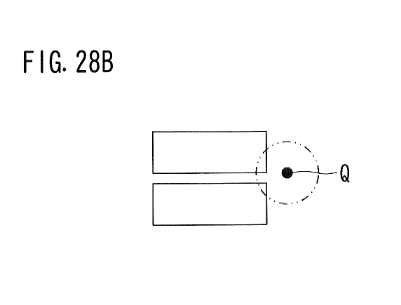

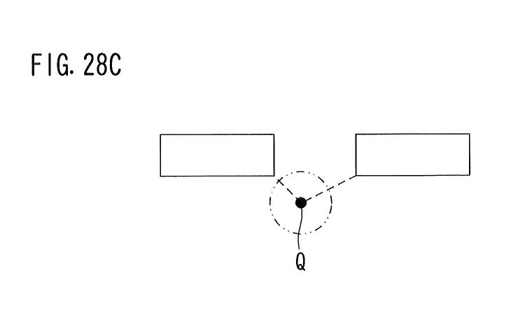

FIG. 27 is a diagram showing another example of the positional relationship among touch panel coordinates P, display surface coordinates Q, and touch panel coordinates PC. FIGS. 28A-28C show examples of the positional relationship between the display surface coordinates Q and an object.

In this embodiment, the image forming apparatus 1A and the image forming apparatus 1B have the same settings as each other in resolution of the liquid crystal display 10k2 and readout resolution of the touch panel 10k3. However, some of the image forming apparatuses 1 have different settings in resolution of the liquid crystal display 10k2 and readout resolution of the touch panel 10k3.

For example, there is a case in which the liquid crystal display 10k2 of the image forming apparatus 1A has a resolution of 800×480 dpi, the touch panel 10k3 of the image forming apparatus 1A has a readout resolution of 800×480 dpi, the liquid crystal display 10k2 of the image forming apparatus 1C has a resolution of 600×360 dpi, and the touch panel 10k3 of the image forming apparatus 1C has a readout resolution of 600×360 dpi. In such a case, the image forming apparatuses 1A and C preferably perform processing in the following manner.

The image forming apparatus 1A outputs, together with the operation log data 5F, resolution data indicating the resolution and the readout resolution of the subject image forming apparatus 1A.

The image forming apparatus 1C obtains, from the image forming apparatus 1A, the operation log data 5F and the resolution data via a USB memory or the communication line NW. In response to this operation, the coordinates correcting portion 133 calculates, in Step #739, the touch panel coordinates P based on the following equation (2) instead of the equation (1).

Touch panel coordinates PC(Xpc,Ypc)=display surface coordinates Q(Rx·Xq,Ry·Yq)+(Ge,Gf) (2)

In the equation (2), Rx=Kxc/Kxa, Ry=Kyc/Kya, Kxa and Kya represent a horizontal resolution (or readout resolution) and a vertical resolution (or readout resolution) of the image forming apparatus 1A respectively. In this example, the former is “800” and the latter is “500”. In the equation (2), Kxc and Kyc represent a horizontal resolution (or readout resolution) and a vertical resolution (or readout resolution) of the image forming apparatus 1B respectively. In this example, the former is “480” and the latter is “360”.

The touch panel coordinates PC are represented by using the touch panel coordinates P of the image forming apparatus 1A as follows. To be specific, the touch panel coordinates PC are represented by: (Rx(Xp−Ga)+Gc, Ry(Yp−Gp)+Gd)=(0.6(Xp−Ga)+Ge, 0.6(Yp−Gb)+Gf) as shown in FIG. 27. The image forming apparatus 1C then performs processing in Step #740 and beyond.

An error sometimes occurs in the conversion from the display surface coordinates Q to the touch panel coordinates P by the coordinates correcting portion 133. In such a case, if the image forming apparatus 1C performs processing based on the erroneous touch panel coordinates P, operation by the user (for example, manual creator) may not be reproduced appropriately. In particular, such a problem may occur when the user operates, in the normal mode, an end part of an object in the screen.

To cope with this, the individual portions of the image forming apparatus 1 preferably perform processing in the reproduction mode as follows.

Referring to FIG. 28A, the display surface coordinates Q corresponding to the touch panel coordinates P are not located on any of the objects (buttons, for example). However, at least a part of an object is contained in a predetermined range from the display surface coordinates Q. In such a case, the operation region determination portion 102 preferably makes region type determination assuming that any position of the object is pressed.

If the region is determined to be a simple operation region, then the touch response processing determination portion 103 preferably determines the touch response processing assuming that the object is tapped.

If the region is determined to be a gesture region, then the gesture response processing determination portion 105 preferably determines the gesture response processing assuming that a gesture is made on the object.

As shown in (B) of FIG. 28, if a plurality of objects are contained in the predetermined range from the display surface coordinates Q, then the operation region determination portion 102 preferably determines the type of a region assuming that an object closest to the display surface coordinates Q is pressed. Likewise, the touch response processing determination portion 103 preferably determines the touch response processing assuming that the object closest to the display surface coordinates Q is tapped. The gesture response processing determination portion 105 preferably determines the gesture response processing assuming that a gesture is made on the object closest to the display surface coordinates Q.

As shown in (C) of FIG. 28, if no object is contained in the predetermined range from the display surface coordinates Q, then the operation region determination portion 102 preferably determines the type of the region assuming that an object closest to the display surface coordinates Q is pressed. As with the determination by the operation region determination portion 102, the touch response processing determination portion 103 and the gesture response processing determination portion 105 preferably determine the touch response processing and the gesture response processing, respectively.

In this embodiment, the image forming apparatus 1B in which the operation is to be reproduced corrects the display surface coordinates Q based on the correction amount data 5U of the subject image forming apparatus 1B to calculate the touch panel coordinates P. Instead of this, however, it is possible that the image forming apparatus 1A in which a record of operation is to be made calculates the touch panel coordinates P based on the correction amount data 5U of the image forming apparatus 1B. Every time one record is read out, the image forming apparatus 1B corrects the display surface coordinates Q to calculate the touch panel coordinates P. Instead of this, it is possible that, before a reproduction command is entered, the image forming apparatus 1B calculates the touch panel coordinates P for all records at one time.

In the case where any one of the terminals 2A-2C remotely controls the image forming apparatus 1 in which a record of operation is to be made or the image forming apparatus 1 in which the operation is to be reproduced, the foregoing processing may be performed in accordance with the specifications or set values of the touch panel display of the controlling terminal 2A, 2B, or 2C.

In this embodiment, the touch panel 10k3 is used which detects a direct contact by a finger or stylus. The present invention is not only limited thereto but also applicable to the case where a non-contact type touch panel is used. Instead of the liquid crystal display 10k2, another kind of display such as a plasma display may be used.

It is desirable that an ordinary format such as Comma Separated Value (CSV) be used as the format of the operation log data 5F, which enables a plurality of image forming apparatuses 1 having different model type to share the operation log data 5F.

The present invention is also applicable to the case where gestures other than those exemplified in this embodiment, for example, rotate and swipe with four fingers are used.

It is to be understood that the configurations of the image forming apparatus 1, the constituent elements thereof, the content and order of the processing, the configuration of data, the configuration of the screens, and the like can be appropriately modified without departing from the spirit of the present invention.

While example embodiments of the present invention have been shown and described, it will be understood that the present invention is not limited thereto, and that various changes and modifications may be made by those skilled in the art without departing from the scope of the invention as set forth in the appended claims and their equivalents.

What is claimed is:

1. An image processing system comprising:
a first image forming apparatus including a first display and a first touch panel laid on a display surface of the first display; and
a second image forming apparatus including a second display and a second touch panel laid on a display surface of the second display, wherein
the first image forming apparatus includes
a first calculation portion configured to calculate a location-on-display-surface which indicates a position, on the display surface of the first display, corresponding to a first touched position on the first touch panel based on first positional relationship data which shows a positional relationship between the display surface of the first display and the first touch panel, and
a generation portion configured to generate operation log data which indicates, for each predetermined time, the location-on-display-surface calculated by the first calculation portion, and
the second image forming apparatus includes
a second calculation portion configured to calculate a corresponding position, in the second touch panel, which corresponds to the location-on-display-surface indicated in the operation log data based on second positional relationship data which shows a positional relationship between the display surface of the second display and the second touch panel,
a determination portion configured to determine display control processing of displaying, on the second display, an operating screen by using the corresponding position calculated by the second calculation portion as a second touched position on the second touch panel, and
a display control portion configured to execute the display control processing determined by the determination portion.

2. The image processing system according to claim 1, wherein the second calculation portion calculates the corresponding position based on a ratio of a size of the second display to a size of the first display.

3. The image processing system according to claim 1, wherein, if the corresponding position is not located on any of objects in a screen displayed on the second display, then the determination portion determines the display control processing assuming that an object closest to the corresponding position is touched.

4. The image processing system according to claim 1, wherein, if the corresponding position is not located on any of objects in a screen displayed on the second display, and if one or more objects is present within a predetermined range from the corresponding position, then the determination portion determines the display control processing assuming that, among said one or more objects, an object closest to the corresponding position is touched.

5. An image forming apparatus comprising:
a display;
a touch panel laid on a display surface of the display;
an obtaining portion configured to obtain operation log data, the operation log data being generated by another image forming apparatus including another display and another touch panel laid on a display surface of said another display, the operation log data indicating a location-on-display-surface, on the display surface of said another display, corresponding to a first touched position on said another touch panel for each predetermined time;
a calculation portion configured to calculate a corresponding position, in the touch panel, which corresponds to the location-on-display-surface indicated in the operation log data based on positional relationship data which shows a positional relationship between the display surface of the display and the touch panel;
a determination portion configured to determine display control processing of displaying, on the display, an operating screen by using the corresponding position calculated by the calculation portion as a second touched position on the touch panel; and
a display control portion configured to execute the display control processing determined by the determination portion.

6. An image forming apparatus comprising:
a display;
a touch panel laid on a display surface of the display;
an obtaining portion configured to obtain operation log data, the operation log data being generated by another image forming apparatus including another display and another touch panel laid on a display surface of said another display, the operation log data indicating a location-on-display-surface, on the display surface of said another display, corresponding to a touched position on said another touch panel for each predetermined time;
a calculation portion configured to calculate a corresponding position, in the touch panel, which corresponds to the location-on-display-surface indicated in the operation log data based on positional relationship data which shows a positional relationship between the display surface of the display and the touch panel;
a determination portion configured to determine display control processing of displaying an operating screen on the display assuming that, among objects in a screen displayed on the display, an object closest to the corresponding position calculated by the calculation portion is touched; and
a display control portion configured to execute the display control processing determined by the determination portion.

7. A method for displaying an operating screen in an image forming apparatus, the image forming apparatus including a display and a touch panel laid on a display surface of the display, the method comprising:
causing the image forming apparatus to perform obtaining processing of obtaining operation log data, the operation log data being generated by another image forming apparatus including another display and another touch panel laid on a display surface of said another display, the operation log data indicating a location-on-display-surface, on the display surface of said another display, corresponding to a first touched position on said another touch panel for each predetermined time;
causing the image forming apparatus to perform calculation processing of calculating a corresponding position, in the touch panel, which corresponds to the location-on-display-surface indicated in the operation log data based on positional relationship data which shows a positional relationship between the display surface of the display and the touch panel;
causing the image forming apparatus to perform determination processing of determining display control processing of displaying, on the display, an operating screen by using the corresponding position calculated by the second calculation portion as a second touched position on the touch panel; and
causing the image forming apparatus to perform the display control processing determined.

8. A method for displaying an operating screen in an image forming apparatus, the image forming apparatus including a display and a touch panel laid on a display surface of the display, the method comprising:
causing the image forming apparatus to perform obtaining processing of obtaining operation log data, the operation log data being generated by another image forming apparatus including another display and another touch panel laid on a display surface of said another display, the operation log data indicating a location-on-display-surface, on the display surface of said another display, corresponding to a touched position on said another touch panel for each predetermined time;
causing the image forming apparatus to perform calculation processing of calculating a corresponding position, in the touch panel, which corresponds to the location-on-display-surface indicated in the operation log data based on positional relationship data which shows a positional relationship between the display surface of the display and the touch panel;
causing the image forming apparatus to perform determination processing of determining display control processing of displaying an operating screen on the display assuming that, among objects in a screen displayed on the display, an object closest to the corresponding position calculated; and
causing the image forming apparatus to perform the display control processing determined.

9. A storage medium storing thereon a computer program used to cause the image forming apparatus to perform the obtaining processing, the calculation processing, the determination processing, and the display control processing according to claim 7.

10. A storage medium storing thereon a computer program used to cause the image forming apparatus to perform the obtaining processing, the calculation processing, the determination processing, and the display control processing according to claim 8.
